(19) United States
(12) Patent Application Publication
(10) Pub. No.: US 2015/0379777 A1
(43) Pub. Date: Dec. 31, 2015

(54) AUGMENTED REALITY PROVIDING SYSTEM, RECORDING MEDIUM, AND AUGMENTED REALITY PROVIDING METHOD

(71) Applicant: MegaChips Corporation, Osaka-shi (JP)

(72) Inventor: Yusuke SASAKI, Osaka-shi (JP)

(73) Assignee: MegaChips Corporation, Osaka-shi (JP)

(21) Appl. No.: 14/846,004

(22) Filed: Sep. 4, 2015

Related U.S. Application Data
(63) Continuation of application No. PCT/JP2014/055222, filed on Mar. 3, 2014.

(30) Foreign Application Priority Data
Mar. 6, 2013 (JP) 2013-043838

(51) Int. Cl. G06T 19/00; G02B 27/01

(52) U.S. Cl. CPC G06T 19/006; G02B 27/0176; G02B 2027/0178; G02B 27/0093

(57) ABSTRACT

An augmented reality providing system is provided with: a group of sensors measuring information on movement; a storage device that stores the reference position of the group of sensors; a card control unit that decides whether or not the group of sensors is located at the reference position; a position and posture identification unit that, after decision by the card control unit that the group of sensors is located at the reference position, identifies the current position of the group of sensors based on the reference position stored in the storage device and the information on the movement measured by the group of sensors; and a display unit that outputs output information in accordance with the current position of the group of sensors identified by the position and posture identification unit, thereby representing augmented reality.

### TECHNICAL FIELD

The present invention relates to a technique for achieving augmented reality that is obtained by augmenting a real environment.

### BACKGROUND ART

A technique for achieving augmented reality (AR), which augments a real environment by giving information created by a computer or the like to information in the real environment, is known conventionally. The augmented reality is usually provided visually. Therefore, for achieving the augmented reality by means of the computer, the computer has to know the field of view of a user who feels the augmented reality, and it is important for the computer to accurately grasp the position of the user.

Thus, as the technique for grasping the user's position, a technique has been proposed which employs a GPS (Global Positioning System) and achieves augmented reality. For example, the technique described in Patent Literature 1 determines the contents of a virtual object to be displayed and a display position thereof in the real environment based on position information of the user acquired by the GPS, and displays real visual information and the virtual object while synthesizing those. In Patent Literature 1, feature information of the surroundings is acquired from a database based on the position information of the user acquired by the GPS, and the virtual object is drawn on a transmission type display. In this manner, the real environment and the virtual object are synthesized.

Moreover, an augmented reality technique using a captured image is also known, for example. As the augmented reality technique using the captured image, there is a method in which an image (marker) having exclusive identification information is installed in a real space, and a predetermined virtual object is drawn on that marker when the marker is present in the captured image. In addition, there is another method that recognizes a specific figure (human body or the like) within the image and draws the virtual image, for example. Patent Literature 2 describes a technique that uses the marker existing in the real environment to enable the virtual object to be displayed while the virtual object is superimposed, for example. Furthermore, Patent Literature 3 describes a technique that does not require the marker as a real object in the real environment and identifies an article arranged in the real space that is known, to enable the virtual object to be displayed.

Patent Literature 1: Japanese Patent Application Laid-open No. 2012-068481

Patent Literature 2: Japanese Patent Application Laid-open No. 2012-141779

Patent Literature 3: Japanese Patent Application Laid-open No. 2003-256876

### SUMMARY OF INVENTION

### Problems to be Solved by the Invention

However, the technique described in Patent Literature 1 has a problem that the display position of the virtual object is shifted because of deterioration of the accuracy of positioning by the GPS in an environment in which a GPS signal is weak. The technique described in Patent Literature 1 has a problem of not being able to even display the virtual object in an environment in which it cannot receive the GPS signal, in the first place. In particular, augmented reality is usually provided indoors, and the GPS signal has a characteristic of being weakened easily indoors. Therefore, the augmented reality and the GPS are not a good combination. Moreover, the augmented reality is achieved by a portable output device. In a case of using the GPS signal, the output device always performs processing while receiving the GPS signal, thus causing increase of the power consumption of the portable output device that has to be driven by a battery.

The techniques described in Patent Literatures 2 and 3 have a problem of failing to recognize the marker or the arranged article when the marker or the arranged article is in some states. Moreover, those techniques have a problem that a specific marker or article must be installed in the real space and may spoil the scenery. In addition, there is a problem that when the displayed contents of the virtual object are changed, the marker or the arranged article in the real environment has to be moved and therefore the versatility is lowered. Furthermore, while the augmented reality is achieved, image recognition processing for a captured image is always required. Thus, there are problems of heavy burden to the computer and large power consumption because the amount of calculation is large.

### Means for Solving the Problems

In order to solve the above problems, according to the invention of claim 1, an augmented reality providing system includes: a sensor configured to measure information on movement; a first storage element configured to store a reference position of the sensor; a decision element configured to decide whether or not the sensor is located at the reference position; a position identification element configured to, after decision by the decision element that the sensor is located at the reference position, identify a current position of the sensor based on the reference position stored in the first storage element and the information on the movement measured by the sensor; and an output element configured to output output information in accordance with the current position of the sensor identified by the position identification element, thereby representing augmented reality.

According to the invention of claim 2, in the augmented reality providing system according to claim 1, the first storage element stores a posture of the sensor at the reference position. The augmented reality providing system further includes a posture identification element configured to, after the decision by the decision element that the sensor is located at the reference position, identify a current posture of the sensor based on the posture of the sensor at the reference position stored in the first storage element and the information on the movement measured by the sensor. The output element outputs the output information in accordance with the current posture of the sensor identified by the posture identification element.

According to the invention of claim 3, the augmented reality providing system according to claim 1 further includes: a portable terminal device of which a position is variable; and an index element of which an absolute position is known. The portable terminal device includes: the sensor; and an acquisition element configured to acquire individual information of the index element. The decision element decides the sensor as being located at the reference position at a time of acquisition of the individual information of the index element by the acquisition element.

According to the invention of claim 4, in the augmented reality providing system according to claim 3, the index element is an installation type device fixed at the absolute position, and the acquisition element includes a first wireless communication element that performs near-field wireless communication with the installation type device when the sensor is located at the reference position.

According to the invention of claim 5, in the augmented reality providing system according to claim 4, the installation type device sends the reference position to the portable terminal device while the near-field wireless communication is performed between the portable terminal device and the installation type device.

According to the invention of claim 6, in the augmented reality providing system according to claim 4, the installation type device sends candidate information that is a candidate of the output information to the portable terminal device, while the near-field wireless communication is performed between the portable terminal device and the installation type device.

According to the invention of claim 7, the augmented reality providing system according to claim 3 includes a plurality of the portable terminal devices. Each of the portable terminal devices includes: a second communication element configured to perform wireless data communication with another one of the portable terminal devices within an augmented reality space; and the output element. The second communication element receives the current position of the sensor included in the other one of the portable terminal devices via the wireless data communication, and the output element outputs the output information in accordance with the current position of the sensor included in the other one of the portable terminal devices, received by the second communication element.

According to the invention of claim 8, in the augmented reality providing system according to claim 3, the portable terminal device includes: a third communication element configured to perform wireless data communication with a terminal device within an augmented reality space; and the output element. The third communication element receives unique information related to the terminal device via the wireless data communication, and the output element outputs the output information in accordance with the unique information related to the terminal device received by the third communication element.

According to the invention of claim 9, the augmented reality providing system according to claim 1 further includes a second storage element configured to store information on an object that is accompanied by the sensor, wherein the output element outputs the output information in accordance with the information on the object stored in the second storage element.

According to the invention of claim 10, the augmented reality providing system according to claim 1 further includes a biological sensor configured to measure biological information related to a living body, wherein the output element outputs the output information in accordance with the biological information measured by the biological sensor.

According to the invention of claim 11, a non-transitory computer-readable storage medium storing computer-readable instructions that, when executed by a computer, cause the computer to perform an augmented reality providing method. The method includes the steps of: measuring information on movement by a sensor; storing a reference position of the sensor in a first storage element; deciding whether or not the sensor is located at the reference position; after decision that the sensor is located at the reference position, identifying a current position of the sensor based on the reference position stored in the first storage element and the information on the movement measured by the sensor; and outputting output information in accordance with the identified current position of the sensor, thereby representing augmented reality.

According to the invention of claim 12, an augmented reality providing method includes the steps of; measuring information on movement by a sensor; storing a reference position of the sensor in a first storage element; deciding whether or not the sensor is located at the reference position; after decision that the sensor is located at the reference position, identifying a current position of the sensor based on the reference position stored in the first storage element and the information on the movement measured by the sensor; and outputting output information in accordance with the identified current position of the sensor to represent augmented reality.

### Advantageous Effects of Invention

The inventions of claims 1 to 12 measure the information on the movement by the sensor, store the reference position of the sensor, decide whether or not the sensor is located at the reference position, and identify, after decision that the sensor is located at the reference position, the current position of the sensor based on the stored reference position and the information on the movement measured by the sensor. Then, those inventions output the output information in accordance with the current position of the sensor thus identified, thereby achieving augmented reality. Thus, it is possible to achieve the augmented reality without installing a marker or the like, even in an environment in which no GPS signal can be received.

### BRIEF DESCRIPTION OF DRAWINGS

FIG. 1 illustrates an augmented reality providing system according to a preferred embodiment.

FIG. 2 is a block diagram of a portable terminal device, a reference position providing device, and a database server in the preferred embodiment.

FIG. 3 shows functional blocks included in the portable terminal device in the preferred embodiment, together with a data flow.

FIG. 4 is a flowchart showing an augmented reality providing method in the preferred embodiment.

FIG. 5 is a diagram illustrating an exemplary displayed view of an augmented reality space provided to a user in the preferred embodiment.

FIG. 6 is a diagram illustrating an exemplary displayed view of the augmented reality space provided to the user in the preferred embodiment.

FIG. 7 illustrates an augmented reality providing system in another preferred embodiment.

FIG. 8 shows functional blocks included in a portable terminal device in the other preferred embodiment, together with a data flow.

FIG. 9 illustrates an example of augmented reality achieved by wireless communication between portable terminal devices.

FIG. 10 illustrates an example of augmented reality achieved by wireless communication between a portable terminal device and a terminal device.

FIG. 11 illustrates an augmented reality providing system in still another preferred embodiment.

FIG. 12 is a block diagram of a portable terminal device in the still other preferred embodiment.

FIG. 13 shows functional blocks included in the portable terminal device in the still other preferred embodiment, together with a data flow.

FIG. 14 is a flowchart showing an augmented reality providing method in the still other preferred embodiment.

FIG. 15 is a diagram showing an example of augmented reality achieved by the augmented reality providing system in the still other preferred embodiment.

FIG. 16 shows an example of display positions of a ghost image within an augmented reality space.

FIG. 17 shows a display example of the ghost image.

FIG. 18 shows a display example of the ghost image.

FIG. 19 shows a display example of the ghost image.

FIG. 20 shows a modified example in a case where the display of the ghost image is changed in the still other preferred embodiment.

FIG. 21 shows a display example of augmented reality of a search application, provided by the augmented reality providing system in the still other preferred embodiment.

FIG. 22 shows a display example of the augmented reality of the search application, provided by the augmented reality providing system in the still other preferred embodiment.

### DESCRIPTION OF REFERENCE SIGNS

1, 1a, 1b, 1c Augmented reality providing system
10 Reference position providing device
100 Contactless IC card reader unit
21, 101, 110 Storage device
102, 111, 210 Program
103 Reference information
11 Database server
112 Candidate information
12, 12a, 12b, 12c, 12d Terminal device
2, 2a, 2b Portable terminal device
20 CPU
200 Card control unit
201, 201a Position and posture identification unit
202, 202a Augmented reality formation unit
211 Owner information
212 Measurement information
213, 213d Captured image information
213a Image in shop
213b, 213c Image in game center
214 Position information
215 Output information
215a Route
215b, 215c, 215d Advertisement
215e Image in shop
215f Route
215g Star mark
215h, 215i Coupon
215j Avatar image
215k, 215p, 215t, 215v Message
215m, 215n Character image
215q Willow image
215r Ghost image
215s Treasure box image
215u Compass image
216 Biological information
22 Operation unit
23, 23a Display unit
24 Group of sensors
25 Image capturing unit
26 Contactless IC card unit
27 Communication unit
28 Biological sensor
29 Speaker
9 Augmented reality space
90 Circle

### DESCRIPTION OF EMBODIMENTS

Preferred embodiments of the present invention are described below in detail with reference to the accompanying drawings. In the following, the descriptions related to directions and orientations correspond to those in the drawings for convenience of explanation, but are not intended to limit products for which the present invention is put into practice, manufactured products, or the scope of the patent right, for example.

The present application claims priority from Japanese Patent Application No. 2013-043838 filed in Japan on Mar. 6, 2013, the contents of which are hereby incorporated by reference.

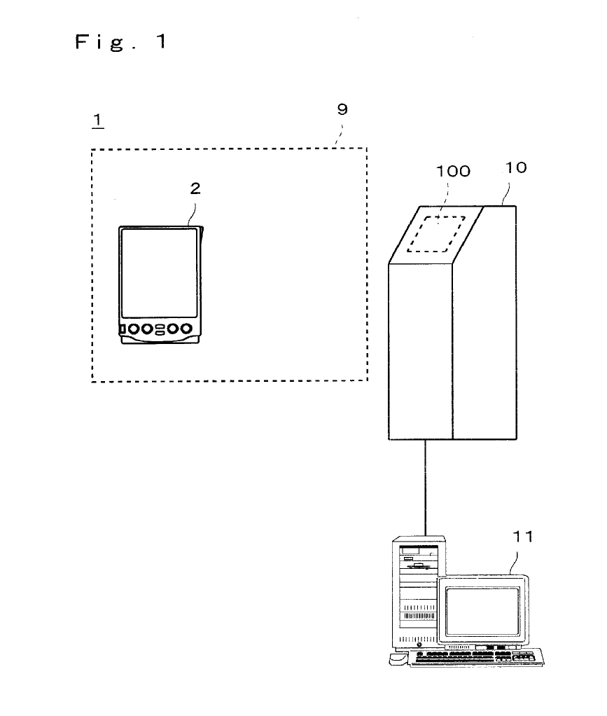

FIG. 1 illustrates an augmented reality providing system 1 in a preferred embodiment. An augmented reality space 9 in FIG. 1 schematically shows an area in which augmented reality is provided by the augmented reality providing system 1.

The augmented reality providing system 1 includes a portable terminal device 2, a reference position providing device 10 of which an absolute position is known and which is configured as an installation type device fixed to the known absolute position, and a database server 11. The numbers of the portable terminal devices 2, the reference position providing devices 10, and the database servers 11 are not limited to those shown in FIG. 1.

In the augmented reality providing system 1, devices provided and installed by a system operator can be considered as the reference position providing device 10 and the database server 11. On the other hand, as the portable terminal device 2, a device owned by a user who comes to an area where the system operator is to provide augmented reality is considered, which corresponds to a cell phone, a smartphone, or a PDA terminal owned by an individual.

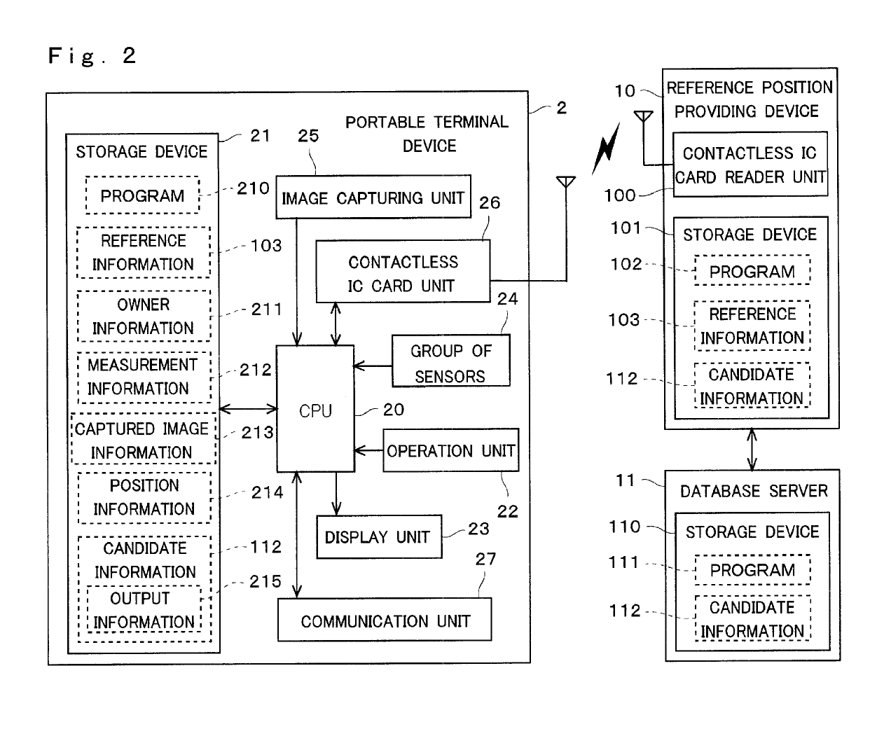

FIG. 2 is a block diagram of the portable terminal device 2, the reference position providing device 10, and the database server 11 in the preferred embodiment.

The portable terminal device 2 includes a CPU 20, a storage device 21, an operation unit 22, a display unit 23, a group of sensors 24, an image capturing unit 25, a contactless IC card unit 26, and a communication unit 27. The portable terminal device 2 is carried by a user, thereby being configured as a device that moves while accompanying the user as an object (i.e., a device of which the position is variable). Moreover, because the portable terminal device 2 includes the group of sensors 24, the group of sensors 24 are also placed in a state in which they accompany the user as the object.

The CPU 20 executes a program 210 stored in the storage device 21 while reading it, and calculates various types of data and generates a control signal, for example. Thus, the CPU 20 has a function of controlling respective components included in the portable terminal device 2 and calculating and generating various types of data. That is, the portable terminal device 2 is configured as a general computer.

The storage device 21 provides a function of storing various types of data in the portable terminal device 2. In particular, the storage device 21 is used for storing a program 210, reference information 103, candidate information 112, measurement information 212, position information 214, output information 215, captured image information 213, and owner information 211.

Exemplary devices corresponding to the storage device 21 are a RAM or a buffer used for a temporal working area of the CPU 20, a read-only ROM, a non-volatile memory (e.g., a NAND memory), a hard disk that can store a relatively large amount of data, and a portable storage medium (e.g., a CD-ROM, a PC card, an SD card, and a USB memory) mounted onto a dedicated reading device. In FIG. 1, the storage device 21 is shown as if it formed one structure. However, the storage device 21 is usually formed by a plurality of types of devices of the above exemplified various devices (or medium), that are employed as necessary. That is, the storage device 21 is a general term referring to a group of devices having a function of storing data (this is the same for storage devices 101 and 110 described later).

An actual CPU 20 is an electronic circuit in which a RAM allowing a high-speed access thereto is provided. Such a storage device provided in the CPU 20 is described as being also included in the storage device 21 for convenience of explanation. That is, in the preferred embodiment, the description is made assuming that data temporally stored by the CPU 20 itself is also stored in the storage device 21.

The operation unit 22 is hardware operable by a user for inputting an instruction to the portable terminal device 2 (augmented reality providing system 1). Examples of the operation unit 22 are various keys, buttons, a touch panel, and a pointing device.

The display unit 23 is hardware having a function of displaying various types of data to output the data. Examples of the display unit 23 are a lamp, an LED, a liquid crystal display, and a liquid crystal panel. In particular, the display unit 23 in the preferred embodiment has a liquid crystal display that displays an image on its screen and has a function of achieving augmented reality by outputting output information 215.

The group of sensors 24 are formed by a plurality of sensors that measure information on movement. As the sensors included in the group of sensors 24, detection devices for performing relative positioning, such as an acceleration sensor, a gyro sensor, and a terrestrial magnetism sensor, are usable. The output of the group of sensors 24 (measured value) is transferred to the storage device 21 and is stored therein as measurement information 212. Based on the measurement information 212, the CPU 20 calculates a moving route by “movement”, the details of which will be described later.

Strictly speaking, the moving route calculated based on the measurement information 212 measured by the group of sensors 24 is the moving route of the group of sensors 24. However, as described above, in the augmented reality providing system 1 in the preferred embodiment, the user carries the portable terminal device 2 therewith and therefore the group of sensors 24 are in a state in which they accompany the user as the object. Thus, the group of sensors 24 can measure information on which user's movement is reflected. Therefore, the augmented reality providing system 1 regards the moving route of the group of sensors 24 as the moving route of the user accompanied by the group of sensors 24. In the following description, the moving route of the group of sensors 24 and that of the object (user) are not distinguished from each other unless otherwise described, and those are simply referred to as a “moving route”.

The moving route of the group of sensors 24 may be corrected or modified as appropriate by using a conventional technique, to provide the moving route of the object that is more accurate. For example, for the moving route of the user during a period in which the measurement information 212 indicating a walking state of the user is obtained, calculation may be performed by using information such as the average length of the walking stride or the walking speed of the user (e.g., information contained in the owner information 211), instead of using the measurement information 212. Moreover, the sensors in the group of sensors 24 are not limited to the above example.

The image capturing unit 25 includes an optical element such as a lens and a photoelectric conversion element such as a CCD, and has a function of capturing an image of a subject existing in its image capturing range to acquire captured image information 213 representing the real appearance of the subject. That is, the image capturing unit 25 has the structure and the function of a general digital camera.

Although the details will be described later, in the preferred embodiment, the display unit 23 displays the captured image information 213 representing the real appearance of the subject really existing therearound and output information 215 selected from candidate information 112 representing an article (including a character) not really existing therearound while synthesizing them, thereby representing augmented reality on its screen. Moreover, in the following description, the captured image information 213 is a color moving picture formed by a plurality of frame images, unless otherwise described.

The contactless IC card unit 26 has the structure and the function of a general contactless IC card. Thus, the portable terminal device 2 is allowed to perform near-field wireless communication with a contactless IC card reader unit 100 of the reference position providing device 10. As the circuit structure and the function of the contactless IC card unit 26, for example, a conventional technique (such as various types of standard specifications) can be employed as appropriate. Therefore, the detailed description of the circuit structure and the function of the contactless IC card unit 26 is omitted.

In this manner, the portable terminal device 2 includes the contactless IC card unit 26. Therefore, a user can acquire necessary information from the reference position providing device 10 to the side of the contactless IC card unit 26 by bringing the portable terminal device 2 close to the contactless IC card reader unit 100 of the reference position providing device 10 and placing the portable terminal device 2 over the contactless IC card reader unit 100. In particular, the portable terminal device 2 in the preferred embodiment acquires reference information 103 and candidate information 112 from the reference position providing device 10. In the following description, an operation sequence in which the user brings the portable terminal device 2 close to the contactless IC card reader unit 100 and places the portable terminal device 2 over the contactless IC card reader unit 100 is referred to as a “communication enabling operation”.

The communication unit 27 provides a function in which the portable terminal device 2 performs wireless communication with an external device. The communication provided by the communication unit 27 is not limited to data communication but may be a telephone call.

The reference position providing device 10 is a device installed in the vicinity of an area where augmented reality is provided. The reference position providing device 10 is configured as an installation type device of which an absolute position is known and which is fixed to the absolute position. As shown in FIG. 2, the reference position providing device 10 includes a contactless IC card reader unit 100 and a storage device 101. Although the detailed structure of the reference position providing device 10 is not shown in FIG. 2, the reference position providing device 10 includes a CPU, an operation unit, a display unit, and a communication unit, for example, and is configured as a general computer.

The contactless IC card reader unit 100 can perform near-field wireless communication with a general contactless IC card to read various types of information stored in the contactless IC card, and can send various types of information to the contactless IC card. To such a contactless IC card reader unit 100, a conventional technique can be applied. Therefore, the detailed description thereof is omitted. The contactless IC card reader unit 100 in the preferred embodiment performs near-field wireless communication with the contactless IC card unit 26 provided in the portable terminal device 2.

A case defining the outer surface of the reference position providing device 10 has the appearance suitable for the communication enabling operation performed by the user, as illustrated in FIG. 1. That is, the case has the appearance that clearly defines the position and the posture of the portable terminal device 2 (the group of sensors 24) when the user performs the communication enabling operation. Specifically, at the position of the contactless IC card reader unit 100, the outer surface of the case is a flat surface inclined with respect to a horizontal surface. Also, the outer surface at that position is designed to have a different color from that of other portions. Thus, the user can correctly perform the communication enabling operation without confusion.

The position and the posture of the portable terminal device 2 while the user performs the communication enabling operation are defined by the case of the reference position providing device 10, as described before. Moreover, because the absolute position of the reference position providing device 10 is known and the reference position providing device 10 is an installation type device, that absolute position is not easily changed. Therefore, the position and the posture of the portable terminal device 2 (the group of sensors 24) can be regarded as being known, when the contactless IC card reader unit 100 of the reference position providing device 10 and the contactless IC card unit 26 of the portable terminal device 2 are performing data communication with each other.

In the augmented reality providing system 1 in the preferred embodiment, the position of the portable terminal device 2 (the group of sensors 24) when the contactless IC card reader unit 100 of the reference position providing device 10 and the contactless IC card unit 26 of the portable terminal device 2 are performing data communication with each other is referred to a “reference position”, and the posture (orientation) of the group of sensors 24 at that reference position is referred to as a “posture at the reference position”.

The reference position and the posture at the reference position can be measured in advance for every reference position providing device 10 when the reference position providing devices 100 are installed, and can be stored as the reference information 103. That is, the reference information 103 corresponds to individual information of the reference position providing device 10, and is information indicating the position and the posture (orientation) of the group of sensors 24 when the contactless IC card reader unit 100 and the contactless IC card unit 26 are performing data communication with each other. The reference position providing device 10 has a function of sending the reference information 103 to the portable terminal device 2 to provide that reference information 103 to that portable terminal device 2.

The storage device 101 is a general term referring to devices each having a function of storing information in the reference position providing device 10. In particular, the storage device 101 stores a program 102 to be executed by a CPU (not shown) of the reference position providing device 10, the reference information 103 as individual information of the reference position providing device 10, and candidate information 112 acquired from the database server 11.

The database server 11 includes the storage device 110, as illustrated in FIG. 2. Although the detailed structure of the database server 11 is omitted in FIG. 2, the database server 11 includes a CPU, an operation unit, a display unit, and a communication unit, for example, and is configured as a general computer.

The database server 11 is different from the reference position providing device 10 in being installable at various locations that are not limited to locations near the area where augmented reality is provided. Examples of the locations of installation of the database serve 11 are the inside of the center of the system operator and a space that is not used for service. The database server 11 is connected to the reference position providing device 10 via a network such as LAN, the Internet, and a public network, and sends candidate information 112 to the reference position providing device 10 as necessary.

The storage device 110 is a general term referring to devices each having a function of storing information in the database server 11. In particular, the storage device 110 stores a program 111 to be executed by a CPU (not shown) of the database server 11 and the candidate information 112.

The candidate information 112 is information related on the material (content) used for providing augmented reality. The candidate information 112 is created by an operator of the database server 11, a designer, or a programmer, for example, and is stored in the storage device 110. Specifically, the candidate information 112 is graphic information of a virtual object displayed in augmented reality, information on the position thereof, information on time thereof, and map information in the augmented reality space 9 (i.e., layout data), for example. To each unit of information contained in the candidate information 112, a tag (classification, explanation, or the like) referred to when selection of the output information 215 is performed is added.

The candidate information 112 is usually information that is different for every augmented reality provided around the reference position providing device 10. Moreover, the candidate information 112 is sent from the database server 11 for every reference position providing device 10. In addition, when the contents of the augmented reality that is being provided are changed, the candidate information 112 is updated in the database server 11 and is uploaded to the corresponding the reference position providing device 10.

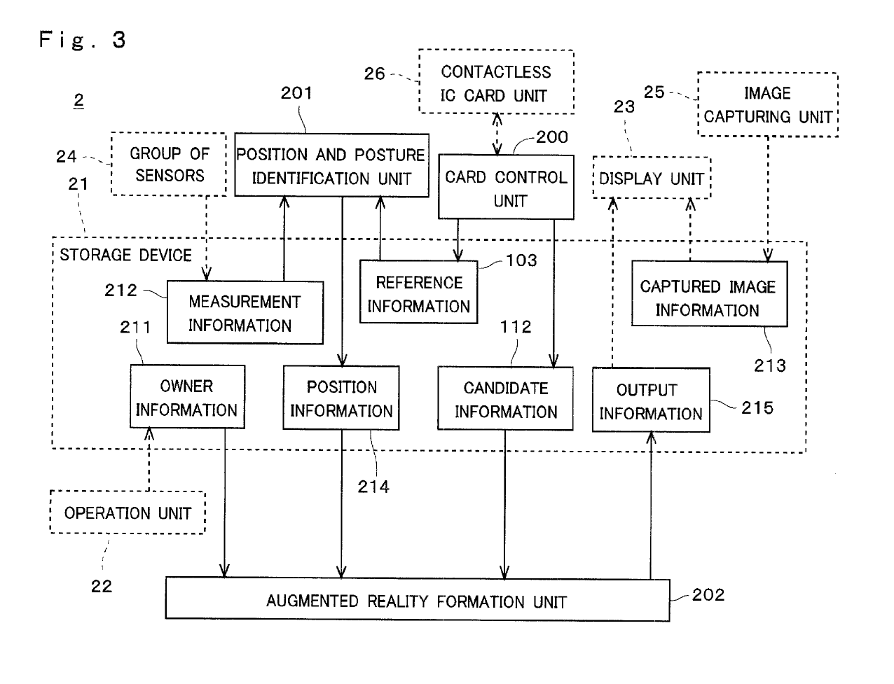

FIG. 3 shows functional blocks provided in the portable terminal device 2 in the preferred embodiment, together with a data flow. A card control unit 200, a position and posture identification unit 201, and an augmented reality formation unit 202 illustrated in FIG. 3 are functional blocks achieved by the operation of the CPU 20 in accordance with the program 210.

The card control unit 200 has a function of controlling the contactless IC card unit 26 to control near-field wireless communication with the reference position providing device 10. That is, the card control unit 200 forms an interface with the contactless IC card unit 26, and transfers the reference information 103 and the candidate information 112 received by the contactless IC card unit 26, to the storage device 21 to make the storage device 21 store the reference information 103 and the candidate information 112. Although FIG. 3 does not show that some information is read out from the storage device 21 and is sent from the contactless IC card unit 26, such information may exist. That is, it is not necessary that the contactless IC card unit 26 is a read-only type.

As described before, in the preferred embodiment, at the start of near-field wireless communication between the contactless IC card unit 26 and the contactless IC card reader unit 100 of the reference position providing device 10, it is decided that the portable terminal device 2 (group of sensors 24) are located at the reference position. That is, the time of decision by the card control unit 200 that the contactless IC card unit 26 has received the reference information 103 is the time at which the portable terminal device 2 (group of sensors 24) is decided as being located at the reference position. Thus, the card control unit 200 in the preferred embodiment has a function corresponding to a decision element according to the present invention.

The position and posture identification unit 201 calculates the moving route as a result of relative positioning, based on the measurement information 212 measured by the group of sensors 24. Please note that the “information related to movement” observed by the group of sensors 24 also contains information related to rotational movement. Therefore, in the moving route calculated by the position and posture identification unit 201, not only the history of the position change (movement track) but also information on the change of the posture are contained.

Based on the absolute position of the starting point of the moving route obtained by the calculation, the position and posture identification unit 201 converts the position of the end point of the moving route to the absolute position, thereby identifying the current position of the portable terminal device 2 (group of sensors 24) and identifying the current posture of the portable terminal device (group of sensors 24). The absolute position of the starting point of the moving route is the reference position contained in the reference information 103.

In other words, the position and posture identification unit 201 has a function of, after having received the reference information 103, identifying the current position of the portable terminal device 2 and also identifying the current posture of the portable terminal device 2 based on the reference information 103 stored in the storage device 21 and the measurement information 212. In the preferred embodiment, “after the reference information 103 has been received” is “after the decision by the card control unit 200 that the group of sensors 24 is located at the reference position has been made”. Moreover, the measurement information 212 is information related to the movement measured by the group of sensors 24. That is, the position and posture identification unit 201 in the preferred embodiment has functions corresponding to a position identification element and a posture identification element according to the present invention.

The current position and the current posture of the portable terminal device 2 identified by the position and posture identification unit 201 are stored as position information 214 in the storage device 21.

The augmented reality formation unit 202 has a function of extracting the output information 215 from the candidate information 112 that is the material for representing augmented reality by referring to the position information 214 obtained by the position and posture identification unit 201 and the owner information 211.

The owner information 211 is information that is input from a user through the operation of the operation unit 22 by the user and is related to that user, and in more details, is information on the characteristics of an object. Specifically, the owner information 211 is personal information such as the age, the gender, the occupation, the address, the hobbies, the preference, the action (purchase) history, the clinical history (presence/absence of allergy), the marital status, the family structure, and the properties (such as a car and a house). Those types of information is not limited to information directly input from the operation unit 22, but may be automatically gathered by another application.

The output information 215 is information displayed on the screen of the liquid crystal display in the display unit 23 in the preferred embodiment, and corresponds to information for augmenting the reality in the provided augmented reality. The display unit 23 displays the output information 215 while superimposing (synthesizing) it on the captured image information 213 or adding it to the captured image information 213, thereby presenting the augmented reality on the screen. The output information 215 may be processed by the augmented reality formation unit 202 when being extracted from the candidate information 112. That is, information related to that processing may be contained in the candidate information 112.

The structure and the functions of the augmented reality providing system 1 in the preferred embodiment are described above. Next, it is specifically described how to provide augmented reality to a user by using the augmented reality providing system 1.

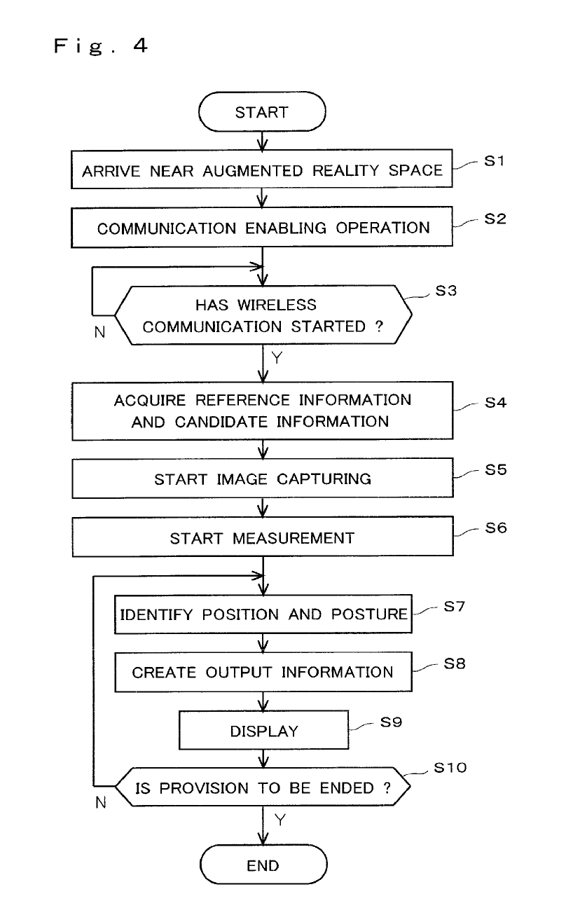

FIG. 4 is a flowchart showing an augmented reality providing method in the preferred embodiment. In the preferred embodiment, an example is described in which shop guide in a complex of shops such as a department store or a shopping mall, is achieved by using augmented reality. That is, an application for guiding a user to a target stop while assuming the inside of the complex of shops as the augmented reality space 9 is described as an example. Therefore, the candidate information 112 in the preferred embodiment contains a map of the complex of shops, position information of each shop arranged in the map, advertisement information, coupon information, and the like.

It is assumed that before each step in FIG. 4 is started, the portable terminal device 2 is started, a predetermined initial setting is completed, and owner information 211 is stored in the storage device 21. It is also assumed that the reference information 103 and the candidate information 112 have been already stored in the storage device 101 of the reference information providing device 10. Moreover, although FIG. 4 illustrates respective steps for one user for convenience of the description, the augmented reality providing system 1 can provide augmented reality to a plurality of users (a plurality of portable terminal devices 2) at a time.

When arriving at the complex of shops (augmented reality space 9) (Step S1), the user performs the communication enabling operation for the reference position providing device 10 installed in the entrance by using the portable terminal device 2 carried therewith (Step S2).

In the preferred embodiment, the augmented reality providing system 1 hardly provides the augmented reality to the user unless that user performs the communication enabling operation. Therefore, it is preferable to provide a system that can urge the user to perform the communication enabling operation without fail at the time of arrival, for example.

Such a system may be configured in such a manner that a visit point is added to the portable terminal device 2 by the communication enabling operation, for example. By this configuration, it is possible to more promote the communication enabling operation of the user who wants to collect visit points. Of course, a poster for urging a customer (user) to perform the communication enabling operation may be put up near the entrance.

The communication enabling operation (Step S2) is performed by the user, thereby near-field wireless communication is started between the contactless IC card unit 26 of the portable terminal device 2 and the contactless IC card reader unit 100 of the reference position providing device 10. Thus, the CPU 20 (card control unit 200) of the portable terminal device 2 gives an affirmative result in the decision of Step S3. That is, at the time of the decision of Yes in Step S3, the card control unit 200 decides that the portable terminal device 2 (group of sensors 24) is located at the reference position.

When wireless communication has been started, the portable terminal device 2 acquires the reference information 103 and the candidate information 112 from the reference position providing device 10 (Step S4). Thus, the reference information 103 and the candidate information 112 are stored in the storage device 21.

In parallel with the process in Step S4, the image capturing unit 25 starts image capturing of the surroundings (inside of the augmented reality space 9) (Step S5). Thus, a state is started in which captured image information 213 is acquired in accordance with an image capturing period. Although the process in Step S5 is automatically started by the communication enabling operation in the preferred embodiment, it may be started by an instruction of the user (an operation of the operation unit 22 by the user).

In parallel with the process in Step S5, the group of sensors 24 start measurement of information related to the movement (Step S6). Thus, a state in which measurement information 212 is updated in accordance with a period of the measurement by the group of sensors 24 is started. That is, the state is started in which the information related to the movement of the user (portable terminal device 2) within the augmented reality space 9 continues to be gathered by the group of sensors 24 as the measurement information 212.

When Steps S4 to S6 have been performed, the position and posture identification unit 201 identifies the current position and the current posture of the portable terminal device 2 (Step S7) based on the reference information 103 (information on the starting point of the moving route) and the measurement information 212 (information for obtaining the moving route), and creates position information 214.

The augmented reality formation unit 202 then determines the absolute position and the posture in the augmented reality space 9 in accordance with the position information 214, and determines a point of view and a gaze direction in that augmented reality. The augmented reality formation unit 202 extracts output information 215 from the candidate information 112 in accordance with the point of view and the gaze direction thus determined (Step S8).

When the point of view and the gaze direction are determined, a field of view in the augmented reality space 9 can be also determined. When the field of view in the augmented reality space 9 is determined, a thing to be virtually displayed (virtual object) corresponding to that field of view and the shape of that thing are determined, for example. In this manner, the augmented reality formation unit 202 can select appropriate output information 215 from the candidate information 112. To the principle for selecting the output information 215 based on the position information 214 after creation of that position information 214, a conventional technique can be applied as appropriate.

In the preferred embodiment, as “the point of view and the gaze direction” determined by the augmented reality providing unit 202 are more coincident with “a point of image capturing (center of the image capturing range) and a direction of image capturing” by the image capturing unit 25, a sense of incongruity of the user when the output information 215 and the captured image information 213 are synthesized and displayed is reduced. Therefore, it is preferable that the position and posture identification unit 201 creates the position information 214, considering this point (i.e., the position and the orientation of the image capturing unit 25 of the portable terminal device 2).

In the shop guide in the complex of shops, the virtual object to be displayed (e.g., the guide route) has to be changed when the user's destination is different even if the current position of the user (the position information 214) is the same. That is, the output information 215 has to be selected in accordance with information different from the position information 214, such as the destination. Therefore, the augmented reality formation unit 202 in the preferred embodiment extracts the output information 215 by referring to not only the position information 214 but also the owner information 211.

First, the augmented reality formation unit 202 determines a shop to which the user wants to go from a plurality of shops in the complex of shops in accordance with the owner information 211. As the information for such determination, the hobbies, the purchase history, the visit history, and the shop search history of the user contained in the owner information 211, and the shop name input as the destination by the user can be used, for example. Information usually recorded as the owner information 211 is not fixed. Therefore, the augmented reality formation unit 202 weighs information that is highly likely to exist in the owner information 211 in advance (i.e., giving priorities), and performs evaluation of each unit of the actually stored information with the weight added thereto, when referring to the information, thereby determining the target shop of the user.

With a device provided by the system operator, it is difficult to comprehensively gather the owner information 211 that is the personal information of the user. This is because the user who is concerned about leakage of personal information is reluctant to provide its personal information to another person's device. However, because the portable terminal device 2 in the preferred embodiment is owned by the user, it is expected that the resistance of the user to input of the personal information is lower. Thus, it is possible to accurately gather the owner information 211 in detail in advance. Moreover, it is possible to urge the user to input required information by an application, depending on the situation. In this manner, the augmented reality formation unit 202 in the preferred embodiment can correctly expect the shop to which the user wants to go.

When the shop to which the user wants to go can be expected, the augmented reality formation unit 202 can identify appropriate output information 215 from the candidate information 112 in accordance with the field of view in the augmented reality space 9, determined based on the position information 214, and the name of the shop thus expected. The augmented reality formation unit 202 may determine the shop to which the user wants to go by using public information such as time. For example, a method can be considered in which during lunchtime a restaurant is selected with higher priority.

When Step S8 has been performed and the output information 215 has been created, the display unit 23 synthesizes and displays the output information 215 and the captured image information 213 on the screen of the liquid crystal display (Step S9). Thus, the display unit 23 represents augmented reality on the screen of the liquid crystal display and provides it to the user.

Thereafter, while it is decided whether to stop providing the augmented reality (Step S10), the processes from Steps S7 to S10 are repeated until an end instruction is issued.

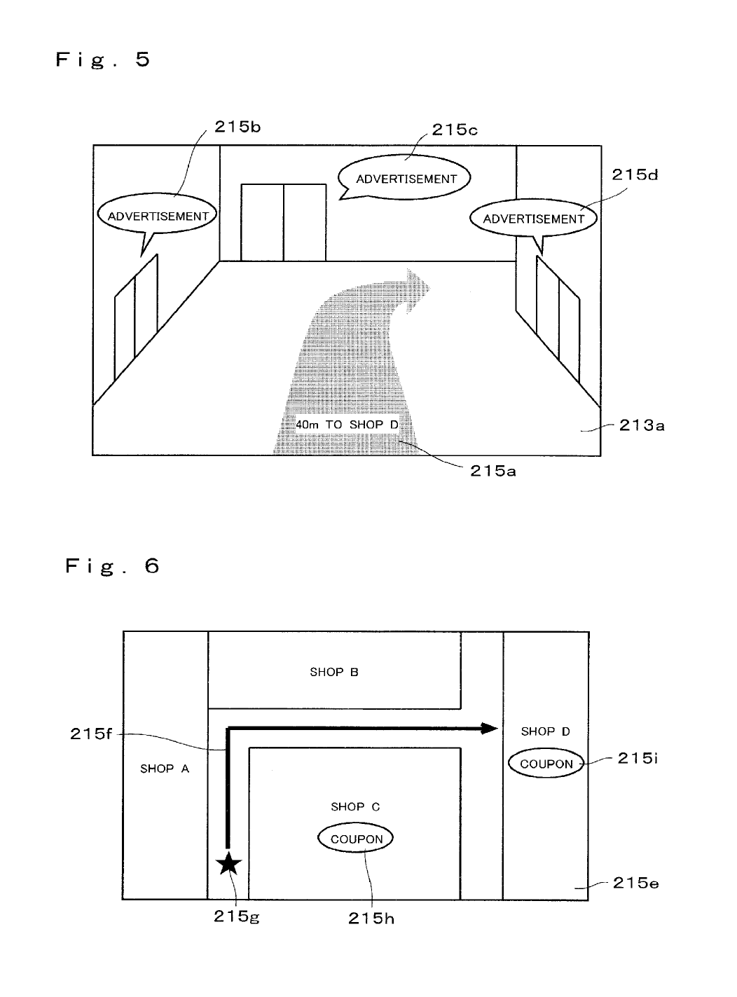

FIG. 5 and FIG. 6 are diagrams illustrating exemplary displayed views of the augmented reality space 9 provided to the user in the preferred embodiment. That is, FIG. 5 and FIG. 6 are examples of an augmented reality display screen displayed on the display unit 23.

FIG. 5 shows that an image in shop 213a, a route 215a, and advertisements 215b, 215c, and 215d that are virtual objects are displayed on the screen of the liquid crystal display.

The image in shop 213a is the captured image information 213 captured by the image capturing unit 25, and is an image representing the real portion in the augmented reality space 9.

The route 215a and the advertisements 215b, 215c, and 215d are the output information 215 selected from the candidate information 112, and are images representing the augmented portions (virtual portions) in the augmented reality space 9, respectively.

The portable terminal device 2 can create and provide the augmented reality display screen by superimposing the view of the augmented environment formed by the virtual objects (the route 215a and the advertisements 215b, 215c, and 215d) on the view of the real environment (the image in shop 213a), as shown in FIG. 5.

The user can become aware of being guided to a shop D by watching the route 215a and can also recognize the route and the distance to the shop D, for example, easily and intuitively as compared with a case in which those are shown in a map or the like. Moreover, when gazing a map or the like, the user may hit a passerby or the like. However, in the augmented reality provided by the augmented reality providing system 1, the passerby is also displayed as the image in shop 213a. Therefore, even if the user is gazing the screen, the user can recognize and avoid a danger of collision easily.

Moreover, the user visually recognizes the advertisements 215b, 215c, and 215d while confirming the route, thus being able to acquire fresh information related to shops near the route. The advertisements 215b, 215c, and 215d can be easily adjusted to have positions, angles, and sizes so that the user directly facing the screen can more easily see them, as compared with POP advertisements or the like arranged in front of actual shops, and can be also provided with animation effects, for example. Therefore, transmission of information, that is effective for the shop as an advertiser, can be performed. That is, also as an advertisement medium for the shop, an excellent effect is exhibited.

On the other hand, the augmented reality formation unit 202 can decide information related to a shop the user does not want to go from the owner information 211, and can prevent the advertisements 215b, 215c, and 215d of shops other than the shop D from being displayed. In addition to this, the augmented reality formation unit 202 can employ a display method in which a shop portion other than the target shop D cannot be seen (for example, by displaying a white wall image at an actual position of the other shop). By doing the above, it is possible to prevent the user from being confused by display of unwanted information, and therefore an application that is suitable for the user and is easy to use can be provided.

FIG. 6 shows that an image in shop 215e and a route 215f, a start mark 215g, and coupons 215h and 215i that are virtual objects are displayed on the screen of the liquid crystal display.

The image in shop 215e is not captured image information 213 captured by the image capturing unit 25, but is a map image obtained by deforming the inside of the actual shop, that is, an image representing the real portion in the augmented reality space 9. In other words, the augmented reality formation unit 202 can also create the image in shop 215e in accordance with the layout or the map of the augmented reality space 9 contained in the candidate information 112. This means that the output information 215 is not limited to information representing a virtual object only.

The route 215f is information that is calculated by the augmented reality formation unit 202 based on the position information 214, the owner information 211, and the candidate information 112 (map information), and is represented by the output information 215 (diagram) selected from the candidate information 112. The route 215f is an image representing the augmented portion (virtual portion) in the augmented reality space 9.

The star mark 215g and the coupons 215h and 215i are the output information 215 selected from the candidate information 112 and are images representing the augmented portions (virtual portions) in the augmented reality space 9.

As shown in FIG. 6, the portable terminal device 2 can create and provide the augmented reality display screen by superimposing the view of the augmented environment formed by the virtual objects (the route 215f, the star mark 215g, and the coupons 215h and 215i) on the view of the real environment (the image in shop 215e).

The user can confirm the whole course to the shop D by visually recognizing the route 215f. Moreover, the user can confirm the current position thereof in the complex of shops by visually recognizing the star mark 215g.

The user can also become aware that coupons are issued in the shops C and D by visually recognizing the coupons 215h and 215i, while confirming the route. The coupon is contained in the candidate information 112, and is selected as the output information 215 when the user faces the casher of the corresponding shop or the like, so that the specific contents of the coupon are displayed as the virtual object on the screen. That is, it is not necessary for the user to operate the device thereof and show the coupon to a shop clerk during payment.

The portable terminal device 2 can switch the screen shown in FIG. 5 and that shown in FIG. 6 in accordance with the instruction from the user. The portable terminal device 2 may display those side by side at the same time. Moreover, when having detected the arrival of the user at the target shop from the position information 214, the portable terminal device 2 may determine a shop as the next target and start guiding to the next target shop. Furthermore, the guide to the shop as the next target may be started at a time at which the user goes out of the first shop.

As described above, the augmented reality providing system 1 in the preferred embodiment includes: the group of sensors 24 measuring measurement information 212; the storage device 21 (the storage devices 101 and 110) storing the reference position of the group of sensors 24; the card control unit 200 that decides whether or not the group of sensor 24 are located at the reference position; the position and posture identification unit 201 that, after decision by the card control unit 200 that the group of sensors 24 are located at the reference position, identifies the current position of the group of sensors 24 based on the reference position stored in the storage device 21 and the measurement information 212 measured by the group of sensors 24; and the display unit 23 that outputs output information 215 in accordance with the current position of the group of sensors 24 identified by the position and posture identification unit 201, thereby representing the augmented reality. Thus, the augmented reality providing system 1 can achieve the augmented reality without installing a marker or the like even in an environment in which no GPS signal can be received.

The storage device 21 stores the posture of the sensor at the reference position. The position and posture identification unit 201 identifies, after the decision by the card control unit 200 that the group of sensors 24 are located at the reference position, the current posture of the group of sensors 24 based on the posture of the group of sensors 24 at the reference position stored in the storage device 21 and the measurement information 212 measured by the group of sensors 24. The display unit 23 outputs the output information 215 in accordance with the current posture of the group of sensors 24 identified by the position and posture identification unit 201. In other words, the augmented reality providing system 1 can determine the posture and the orientation of the user in addition to the absolute position of the user, unlike a GPS. Also, in accordance with those kinds of information, the augmented reality providing system 1 can display an effective virtual object (output information 215) on the line of sight of the user. Thus, the augmented reality with improved reality can be achieved.

Moreover, the reference position providing device 10 as an installation type device fixed to an absolute position is provided, and the portable terminal device 2 includes the contactless IC card unit 26 that performs near-field wireless communication with the reference position providing device 10 when the group of sensors 24 are located at the reference position. Thus, by installing the reference position providing system 10 at a position that can be used immediately before the start of provision of the augmented reality, the group of sensors 24 can be reset immediately before the augmented reality is provided. Therefore, it is possible to suppress accumulation of errors in the group of sensors 24 with the lapse of time.

While near-field wireless communication is performed between the portable terminal device 2 and the reference position providing device 10, the reference position providing device 10 sends reference information 103 to the portable terminal device 2. Thus, the portable terminal device 2 does not need to acquire the reference information 103 in advance.

While near-field wireless communication is performed between the portable terminal device 2 and the reference position providing device 10, the reference position providing device 10 sends candidate information 112 that is a candidate of the output information 215 to the portable terminal device 2. Thus, the portable terminal device 2 does not need to acquire the candidate information 112 in advance. Moreover, since the portable terminal device 2 acquires the candidate information 112 immediately before using it, the portable terminal device 2 can acquire the candidate information 112 that is relatively fresh.

The augmented reality providing system 1 stores owner information 211 as information on an object accompanied by the group of sensors 24, and the display unit 23 outputs the output information 215 in accordance with the stored owner information 211. Thus, the augmented reality corresponding to the object can be provided. In a case where the object is an individual, for example, the augmented reality suitable for that individual can be provided for every individual.

It has been described that the reference information 103 in the preferred embodiment is created in the reference position providing device 10 and stored in the storage device 101. However, information corresponding to the reference information 103 may be created in the database server 11 and be sent to each reference position providing device 10 together with the candidate information 112, for example.

The reference position providing device 10 and the database server 11 may be formed by one computer.

The candidate information 112 may be downloaded to the portable terminal device 2 in advance by data communication between the communication unit 27 of the portable terminal device 2 and the database server 11. That is, the candidate information 112 is not required to be acquired from the reference position providing device 10. In general, data communication between the contactless IC card unit 26 and the contactless IC card reader unit 100 by near-field wireless communication is not suitable for transmission and reception of a huge amount of data. Therefore, as for the candidate information 112 that has a relatively large amount of data, it is preferable to perform transmission and reception thereof by data communication via a general network (e.g., the Internet). It is sufficient that before the augmented reality around the reference position providing device 10 is provided, the user operates the portable terminal device 2 the user owns, makes an access to the database server 11, and downloads in advance the candidate information 112 for the augmented reality to be provided around that reference position providing device 10. In this case, it is preferable that the reference information 103 is also sent from the database server 11 to the portable terminal device 2 together with the candidate information 112.

In order for the augmented reality formation unit 202 to expect the purchase behavior of the user and extract the appropriate output information 215, information indicating the environment of the surroundings such as the temperature or the humidity, is effective in some cases. Therefore, an environmental sensor such as a temperature sensor or a humidity sensor may be provided in the portable terminal device 2, and the augmented reality formation unit 202 may refer to information gathered by such a sensor.

The portable terminal device 2 in the preferred embodiment does not perform data communication for providing the augmented reality in the augmented reality space 9. However, the present invention is not limited to such an embodiment.

FIG. 7 illustrates an augmented reality providing system 1a in another preferred embodiment. The numbers of the portable terminal devices 2a and the terminal devices 12 are not limited to those shown in FIG. 7. Moreover, as a communication counterpart of a portable terminal device 2a within the augmented reality space 9, at least either another portable terminal device 2a or a terminal device 12 may be present.

The augmented reality providing system 1a is different from the structure of the augmented reality providing system 1 in the preferred embodiment in including the portable terminal device 2a in place of the portable terminal device 2 and including the installation type terminal device 12. In the following description, for the augmented reality providing system 1a in the other preferred embodiment, the same structures as those in the augmented reality providing system 1 in the preferred embodiment are labeled with the same reference signs, and the description thereof is omitted as appropriate.

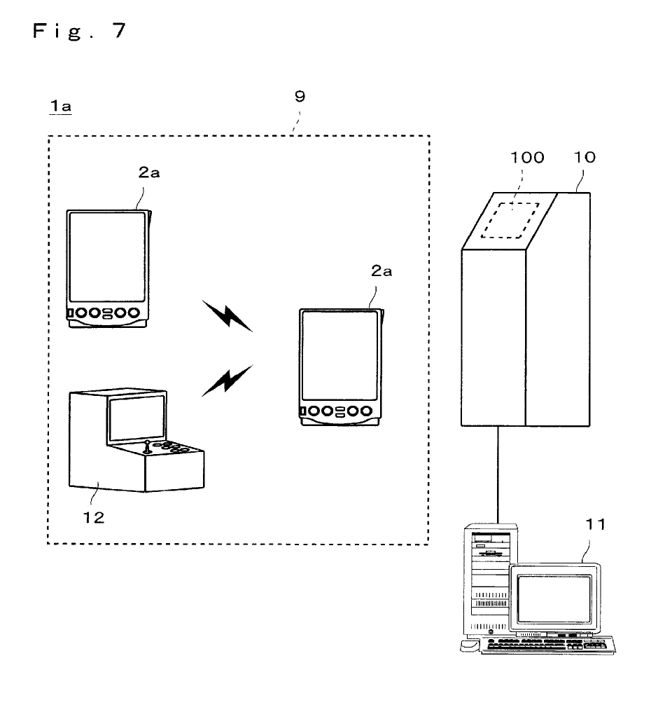

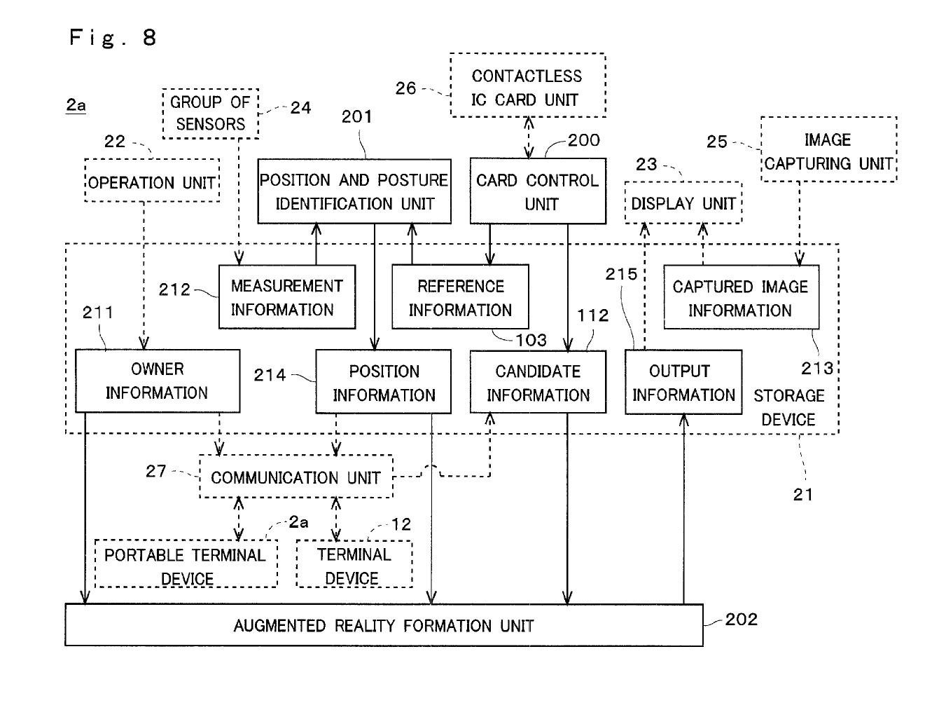

FIG. 8 shows functional blocks of the portable terminal device 2a in the other preferred embodiment, together with a data flow.

The portable terminal device 2a is a device having approximately the same structure as that of the portable terminal device 2 and is movable within the augmented reality space 9 while being carried by a user. The communication unit 27 of the portable terminal device 2a regularly searches for a communication device located in the surroundings thereof, and performs data communication by near-field wireless communication with another portable terminal device 2a or a terminal device 12 that is located within the augmented reality space 9. For the wireless communication method used here, a near-field wireless communication method such as Bluetooth (registered trademark) is suitable, for example. However, the wireless communication method is not limited to Bluetooth (registered trademark).

The communication unit 27 of the portable terminal device 2a sends the owner information 211 and the position information 214 stored in the storage device 21 thereof to the other terminal portable device 2a and the terminal device 12 detected as the communication devices in the augmented reality space 9. The owner information 211 sent to the outside by the communication unit 27 is limited to information permitted by the user, for preventing personal information from leaking.

The communication unit 27 of the portable terminal device 2a stores information received from the other portable terminal device 2a and the terminal device 12 in the storage device 21 of the portable terminal device 2a as the candidate information 112. That is, in the other preferred embodiment, the candidate information 112 is not limited to the information acquired from the reference position providing device 10, but may contain the information gathered from the other portable terminal device 2a and the terminal device 12.

The terminal device 12 is a general installation type computer and is a device of which absolute position is fixed in the augmented reality space 9. The candidate information 112 in the other preferred embodiment contains identification information of the terminal device 12 and information on the absolute position (the position of installation). The terminal device 12 has a function of performing data communication by near-field wireless communication with the communication unit 27 of the portable terminal device 2a, and sends its own unique information (the details will be described later) to the portable terminal device 2a.

The augmented reality providing system 1a in the other preferred embodiment is described below based on an exemplary application in which a game center having a number of game machines (terminal devices 12) installed therein is assumed as the augmented reality space 9. For easy understanding of the description, an example of augmented reality achieved by wireless communication performed by the portable terminal device 2a with the other portable terminal device 2a and an example of augmented reality achieved by wireless communication performed by the portable terminal device 2a with the terminal device 12 are described separately from each other.

First, the example of augmented reality achieved by wireless communication performed by the portable terminal device 2a with the other portable terminal device 2 in the augmented reality providing system 1a is described.

FIG. 9 shows the example of augmented reality achieved by wireless communication between the portable terminal devices 2a. In the example of FIG. 9, an image in game center 213b, an avatar image 215j, and a message 215k are displayed on the display unit 23 of the portable terminal device 2a.

The image in game center 213b is a picture (captured image information 213) inside the game center (augmented reality space 9) captured by the image capturing unit 25 of the portable terminal device 2a. That is, the image in game center 213b is an image representing the real portion in the augmented reality. In this example, three terminal devices 12 are captured.

The avatar image 215j and the message 215k are images presented by displaying the output information 215 selected by the augmented reality formation unit 202 from the candidate information 112. That is, the avatar image 215j and the message 215k are images representing virtual things not existing in reality, and are images representing the augmented portions in the augmented reality.

Both the avatar image 215j and the message 215k are information selected from the candidate information 112, but are not information acquired from the reference position providing device 10. Those are information created based on the owner information 211 and the position information 214 received from the other portable terminal device 2a.

In the other preferred embodiment, the user acquires the reference information 103 and the candidate information 112 from the reference position providing device 10 at the entrance of the augmented reality space 9 as in the preferred embodiment, and enters the game center. Moreover, the user edits the owner information 211 at a given timing (i.e., in the inside and outside of the game center) to set its own avatar, various messages, a play history of a game installed in the game center (that is provided by the terminal device 12), or the profile of the user.

In the game center, the communication unit 27 searches for a communication device (another portable terminal device 2a) near that communication unit 27 and starts communication with the detected other portable terminal device 2a. The portable terminal device 2a exchanges the owner information 211 and the position information 214 with the other portable terminal device 2a, thereafter creates candidate information 112 based on the owner information 211 and the position information 214 of the other portable terminal device 2a thus received, and stores the candidate information 112 in its own storage device 21.

When the field of view in the augmented reality space 9 has been obtained, the augmented reality formation unit 202 selects the output information 215 from the candidate information 112 as in the preferred embodiment. In a case where there is another portable terminal device 2a in that field of view, the output information 215 is selected from the candidate information 112 created based on the owner information 211 received from that other portable terminal device 2a. The current position of the other portable terminal device 2a can be decided from that position information 214 received from the other portable terminal device 2a (more specifically, the candidate information 112 derived from that position information 214).

In this manner, the portable terminal device 2a overwrites and displays the avatar (the avatar image 215j) set by the user of the other portable terminal device 2a in the owner information 211 at the current position of that user on the real image of that user. In addition, the portable terminal device 2a can also display a message (message 215k) set in the owner information 211 received from that other portable terminal device 2a.

As described above, the augmented reality providing system 1a in the other preferred embodiment makes a plurality of portable terminal devices 2a exchange the owner information 211 and the position information 214 with each other. Thus, the user visiting the game center can exchange and display messages, pictographs, characters (avatars), introduction sentences of respective users using play histories of games (e.g., a master of a fighting game, a beginner of a music game) and the like as virtual objects, and can enjoy them.

Next, the example of augmented reality achieved by wireless communication by the portable terminal device 2a with the terminal device 12 in the augmented reality providing system 1a is described.

FIG. 10 shows an example of the augmented reality achieved by wireless communication between the portable terminal device 2a and the terminal device 12. In the example of FIG. 10, an image in game center 213c, character images 215m and 215n, and a message 215p are displayed on the display unit 23 of the portable terminal device 2a.

The image in game center 213a is a picture (captured image information 213) inside the game center (augmented reality space 9) captured by the image capturing unit 25 of the portable terminal device 2a. That is, the image in game center 213c is an image representing the real portion in the augmented reality. In this example, four terminal devices 12 are captured. In the example of FIG. 10, for distinguishing the respective terminal devices 12 from one another, alphabets are added to the respective reference signs, so that the terminal devices 12 are referred to as terminal devices 12a, 12b, 12c, and 12d.

The character images 215m and 215n and the message 215p are images presented by displaying the output information 215 selected by the augmented reality formation unit 202 from the candidate information 112. That is, the character images 215m and 215n and the message 215p are images representing virtual things not existing in reality, and are images representing the augmented portions in the augmented reality.

All the character images 215m and 215n and the message 215p are information selected from the candidate information 112, but are not information acquired from the reference position providing device 10. Those are information created based on information unique to each of the terminal devices 12a, 12b, and 12c received by the portable terminal device 2a.

As described before, in the other preferred embodiment, the communication unit 27 searches for a communication device close thereto in the game center. When the terminal device 12 has been detected, the communication unit 27 starts communication with the thus detected terminal device 12. From the terminal device 12 with which communication has been started, the portable terminal device 2a receives the information unique to that terminal device 12. The portable terminal device 2a then creates the candidate information 112 based on the received unique information and stores it in its own storage device 21.

The position of the terminal device 12 is contained in the candidate information 112 acquired from the reference position providing device 10. Thus, the portable terminal device 2a may receive, only from the terminal device 12 decided to exist in the field of view of the user based on the position of the terminal device 12 acquired in advance, the unique information of that terminal device 12, instead of receiving the unique information from all the terminal devices 12 with which near-field wireless communication has been established. In this case, the amount of information sent/received in data communication can be suppressed.

Similarly to the portable terminal device 2 in the preferred embodiment, the portable terminal device 2a can also determine the field of view of the user in the augmented reality space 9 by determining the point of view and the line of sight of the user. Therefore, the augmented reality formation unit 202 can select the output information 215 from the candidate information 112 derived from the terminal device 12 existing in the field of view of the user (the candidate information 112 created based on the unique information received from that terminal device 12).

Thus, the portable terminal device 2a displays the unique information of each terminal device 12 at a position that corresponds to the position of that terminal device 12. In the example of FIG. 10, the character image 215m in accordance with the play status of the terminal device 12a, the character image 215n in accordance with the play status of the terminal device 12b, and the message 215p indicating the reception status of the terminal device 12c are displayed.

In this manner, the augmented reality providing system 1a in the other preferred embodiment gathers the unique information of the terminal device 12 existing within the augmented reality space 9, in the portable terminal device 2a. Thus, the user visiting the game center can receive, from the terminal device 12 located close thereto, play information, demonstration information, and information on a way of playing of a provided game, for example, and can display them as virtual objects. Moreover, in addition to the decision of the terminal device 12 to be located close thereto, the decision of the field of view of the user within the augmented reality space 9 is performed, thereby the virtual object can be displayed on the line of sight of the user. Therefore, it is possible to represent the augmented reality with improved reality and also represent the augmented reality based on more real-time information as compared with the preferred embodiment. Moreover, by representing the play status as the augmented reality, the view of play (character images 215m and 215n) are displayed so that the user can enjoy the game as an audience.

Information that is not changed frequently, such as the demonstration information or the way of playing the game, may be configured to be received from the reference position providing device 10 as the candidate information 112. That is, the output information 215 is not limited to the information received from the other portable terminal device 2a and the terminal device 12.

In the above description, the information gathered in relation to the object is the owner information 211 and the position information 214 only. However, the information gathered in relation to the object is not limited such information. Moreover, in the preferred embodiment and the other preferred embodiment, the examples are described in which the real portion in the provided augmented reality is also displayed as image information on the display unit 23. However, the real portion in the augmented reality is not necessarily displayed as the image information.

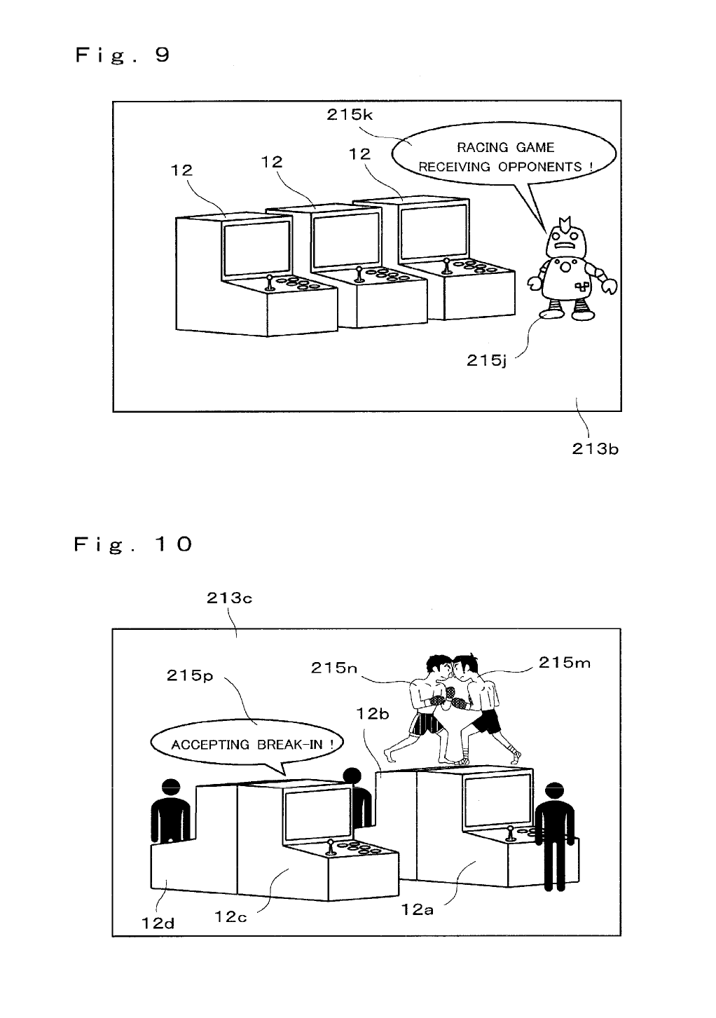

FIG. 11 illustrates an augmented reality providing system 1b in still another preferred embodiment. The augmented reality providing system 1b is different from the augmented reality providing system 1 of the preferred embodiment in having a portable terminal device 2b in place of the portable terminal device 2 and not having the structure corresponding to the reference position providing device 10 and the database server 11. In the following description, for the augmented reality providing system 1b in the still other preferred embodiment, the same structures as those in the augmented reality providing system 1 in the preferred embodiment are labeled with the same reference signs, and the description thereof is omitted as appropriate.

As illustrated in FIG. 11, the portable terminal device 2b is configured as a HMD (Head Mounted Display) type device, and can move while accompanying the user by being worn to the head of the user. As shown in the preferred embodiment, in a case of using a handheld type portable terminal device 2, the relationship of the relative positions between the user and the portable terminal device 2 is changed depending on how the user holds the portable terminal device 2, thus causing an error between the point of view in the augmented reality obtained from the position of the group of sensors 24 (position information 214) and the image capturing point of the image capturing unit 25. However, the augmented reality providing system 1b in the still other preferred embodiment can improve the accuracy in visual coincidence between the real portion and the augmented portion by using a wearable type portable terminal device 2b, as compared with the case of using the handheld type portable terminal device 2. Therefore, it is possible to improve reality of the augmented reality to be provided.

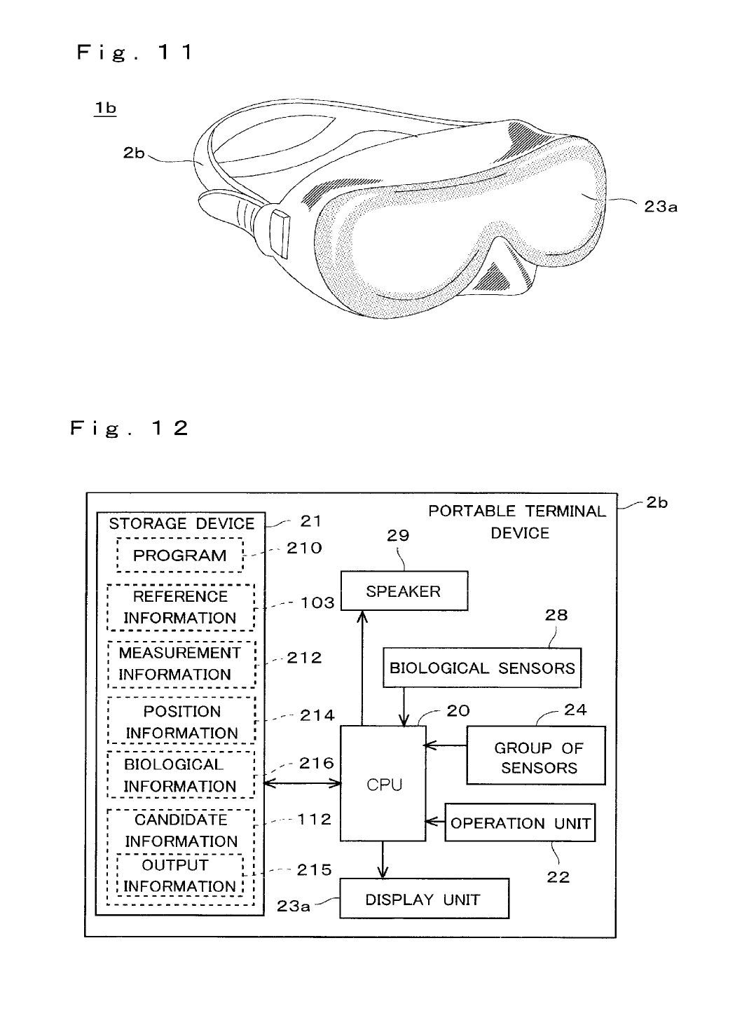

FIG. 12 is a block diagram of the portable terminal device 2b in the still other preferred embodiment.

The portable terminal device 2b is usually a dedicated device owned by the system operator. Thus, the information corresponding to owner information 211 on the user is not stored in the storage device 21.

The portable terminal device 2b includes a display unit 23a having a transmission type display. A real thing arranged in the augmented reality space 9 is viewed and recognized by the user based on light transmitted through that display. Thus, in the augmented reality providing system 1b in the still other preferred embodiment, the image information of the real portion is not displayed when the augmented reality is provided. On the other hand, the display unit 23a displays the output information 215 at a predetermined position on that display, thereby superimposing a virtual object (augmented portion) on the real portion as appropriate.

The portable terminal device 2b does not include the image capturing unit 25 nor has a function of capturing an image of the surroundings. Therefore, in the still other preferred embodiment, information corresponding to the captured image information 213 is not created. This is because it is not necessary to display the real portion on the screen in the portable terminal device 2b, as described before.

Moreover, the portable terminal device 2b does not include the structures corresponding to the contactless IC card unit 26 and the communication unit 27, but is configured as a stand-alone type device. In the storage device 21 of the portable terminal device 2b, the reference information 103 and the candidate information 112 are stored in advance, together with the program 210.

The portable terminal device 2b is provided with a biological sensor 28, in addition to the group of sensors 24. The biological sensor 28 is a device having a function of measuring biological information 216 related to a living body. As the biological sensor 28, a heart rate sensor that measures the heart rate of a user, a respiration sensor that measures information on user's respiration such as the respiration rate, and a microphone that measures the sound generated by the user can be considered, for example. However, the biological sensor 28 is not limited to those devices, but may be a device having a function of gathering information usable for decision of the current physiological condition of the user.

The portable terminal device 2b also includes a speaker 29 that reproduces sounds based on information related to the sounds. In particular, the speaker 29 is used as an output element that outputs information on the sounds contained in the output information 215 as the sounds.

FIG. 13 shows functional blocks of the portable terminal device 2b in the still other preferred embodiment, together with a data flow. The portable terminal device 2b is different from the portable terminal device 2 in not having the card control unit 200 and including a position and posture identification unit 201a and an augmented reality formation unit 202a in place of the position and posture identification unit 201 and the augmented reality formation unit 202.

The position and posture identification unit 201a decides, in response to input information from the operation unit 22, that the portable terminal device 2b (group of sensors 24) is located at the reference position and the current posture thereof is the posture at the reference position. In the still other preferred embodiment, the current position and the current posture of the portable terminal device 2b when the reset button of the operation unit 22 is operated are reset with the reference information 103. That is, in the still other preferred embodiment, the position and posture identification unit 201a has a function corresponding to a decision element according to the present invention.

The augmented reality formation unit 202a extracts the output information 215 from the candidate information 112 in accordance with the position information 214 as in the preferred embodiment. However, since there is no information corresponding to the owner information 211 in the still other preferred embodiment, the augmented reality providing unit 202a does not refer to the owner information 211 when extracting the output information 215. Instead, the augmented reality formation unit 202a extracts the output information 215 in accordance with the biological information 216. Thus, the augmented reality providing system 1b in the still other preferred embodiment (the display unit 23a and the speaker 29) outputs the output information 215 in accordance with the biological information 216 measured by the biological sensor 28.

The augmented reality providing system 1b in the still other preferred embodiment is described below, referring to an application in which a haunted house is the augmented reality space 9, as an example.

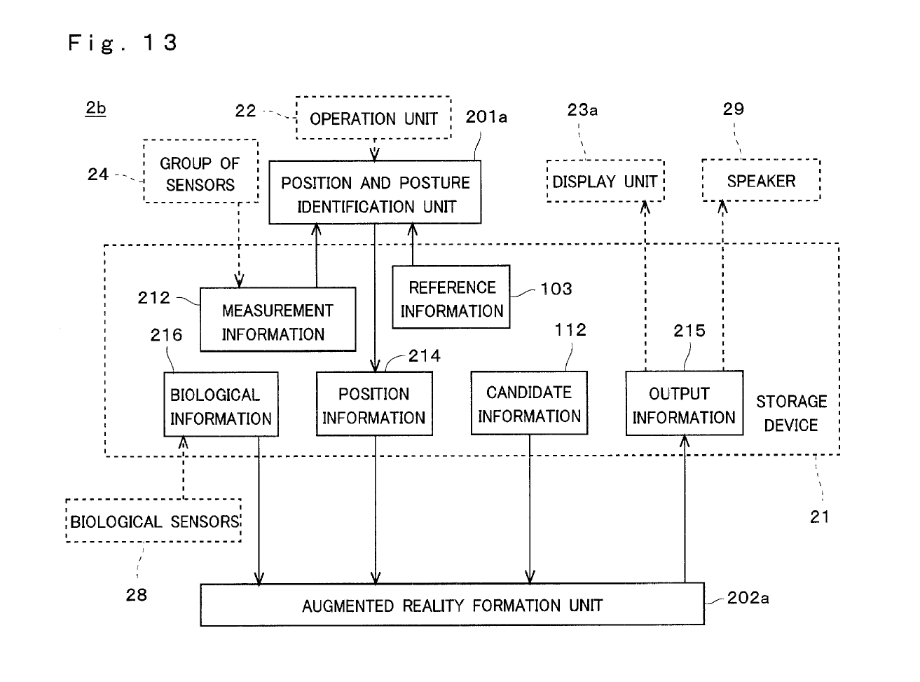

FIG. 14 is a flowchart showing an augmented reality providing method in the still other preferred embodiment.

A counter clerk of the haunted house makes the portable terminal device 2b stand still at a predetermined position with a predetermined posture. In this state in which the portable terminal device 2b stands still, the counter clerk operates the reset button (operation unit 22) (Step S11), and places that portable terminal device 2b in a state in which that portable terminal device 2b can be handed to the user (hereinafter, referred to as a “stand-by state”).

The predetermined position is the position that is coincident with the reference position stored in the reference information 103. The predetermined posture is the posture stored in the reference information 103 (i.e., the posture defined as the posture at the reference position). That is, in the still other preferred embodiment, the counter clerk performs an operation corresponding to the communication enabling operation in the preferred embodiment.

By execution of Step S11, the group of sensors 24 starts measurement of the measurement information 212 (Step S12), and the position and posture identification unit 201a starts creation of the position information 214 based on the reference information 103 and the measurement information 212 (Step S13). The creation of the position information 214 may be configured to be started when the portable terminal device 2b in the stand-by state is moved for being handed to the user. This is because the portable terminal device 2b in the stand-by state stands still and therefore the position and the posture thereof do not change during that period. That is, the operation for transferring the portable terminal device 2b to the stand-by state and the operation for starting calculation of the position information 214 may be distinguished from each other.

Next, when the user has arrived at the entrance of the haunted house, the counter clerk hands the portable terminal device 2b in the stand-by state to that user. That user wears the received portable terminal device 2b thereon (Step S14). Thus, the display unit 23a is arranged in front of the user's eyes, the speaker 29 is arranged near the user's ear, and the biological sensor 28 is attached to the user's body.

The user enters the haunted house (augmented reality space 9) while wearing the portable terminal device 2b (Step S15).

The augmented reality formation unit 202a decides whether or not the user (the portable terminal device 2b) is within the augmented reality space 9 in accordance with the position information 214 (Step S16), and further decides whether or not a flag is ON when the user is not within the augmented reality place 9 (Step S17). The flag is information indicating whether or not the user has entered the augmented reality space 9. The flag is set to “ON” in a case where the user has entered there, and is set to “OFF” in a case where the user has never entered.

In a case where the decision result is No in Step S17, the result shows that the user has never entered the augmented reality space 9. Therefore, it is regarded that the entrance action of the user has not been finished yet, and the procedure goes back to Step S16.

On the other hand, in a case where the user is within the augmented reality space 9 (Yes in Step S16), the CPU 20 sets the flag to ON (Step S18). The augmented reality formation unit 202a then creates the output information 215 based on the position information 214 and the biological information 216 (Step S19).

When Step S19 has been executed, the display unit 23a and the speaker 29 output that output information (Step S20), thereby achieving augmented reality. The processes from Step S16 to S20 are continued until the user is decided as not being within the augmented reality space 9 (i.e., having gone out of the exit).

When the decision result is Yes in Step S17, it is regarded that the user who had entered the augmented reality space 9 once went out of the augmented reality space 9, the CPU 20 sets the flag to OFF (Step S21), and provision of the augmented reality by the portable terminal device 2b is ended. The counter clerk then collects the portable terminal device 2b from the user.

Next, it is described how the biological information 216 is used for selection of the output information 215 in the still other preferred embodiment.

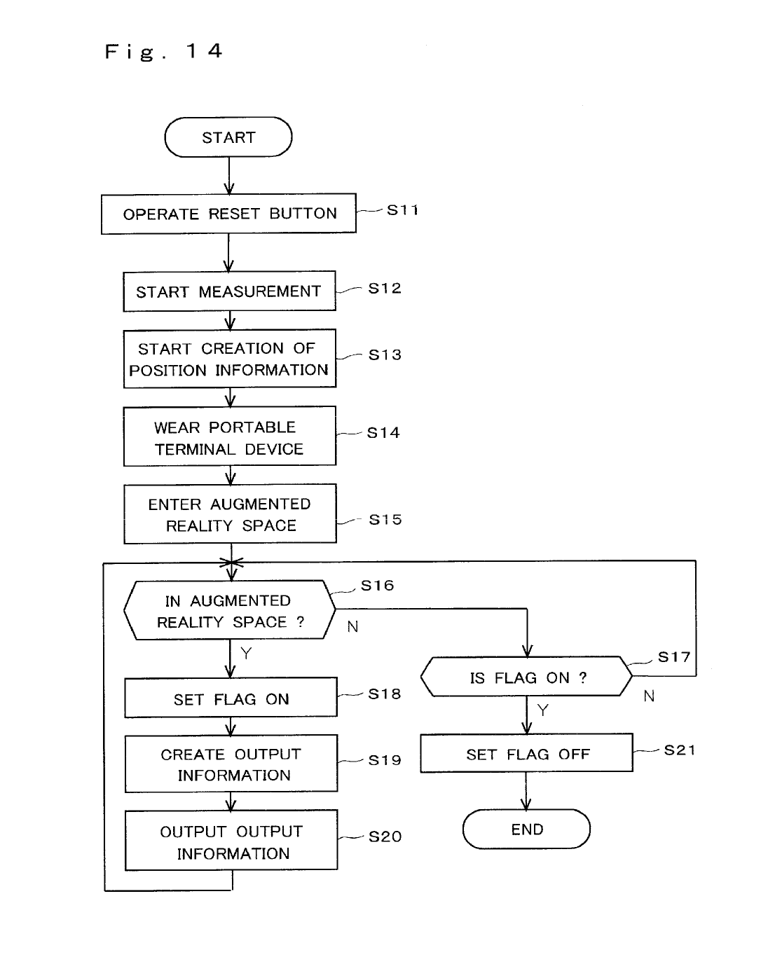

FIG. 15 illustrates an example of the augmented reality achieved by the augmented reality providing system 1b in the still other preferred embodiment. Both a willow image 215q and a ghost image 215r in FIG. 15 are the output information 215, whereas things other than the willow image 215q and the ghost image 215r are real things that can be perceived with light transmitted through the transmission type display.

FIG. 16 illustrates the display positions of the ghost images 215r within the augmented reality space 9. In the example of FIG. 16, eight positions are set in the augmented reality space 9 as the positions at which the ghost images 215r are respectively displayed. In other words, in the candidate information 112, the ghost image 215r to be displayed at the eight positions is prepared in advance. Moreover, a circle 90 in FIG. 16 represents a decision position (that will be described later). Furthermore, hatched portions in FIG. 16 represent a real wall or a real pillar.

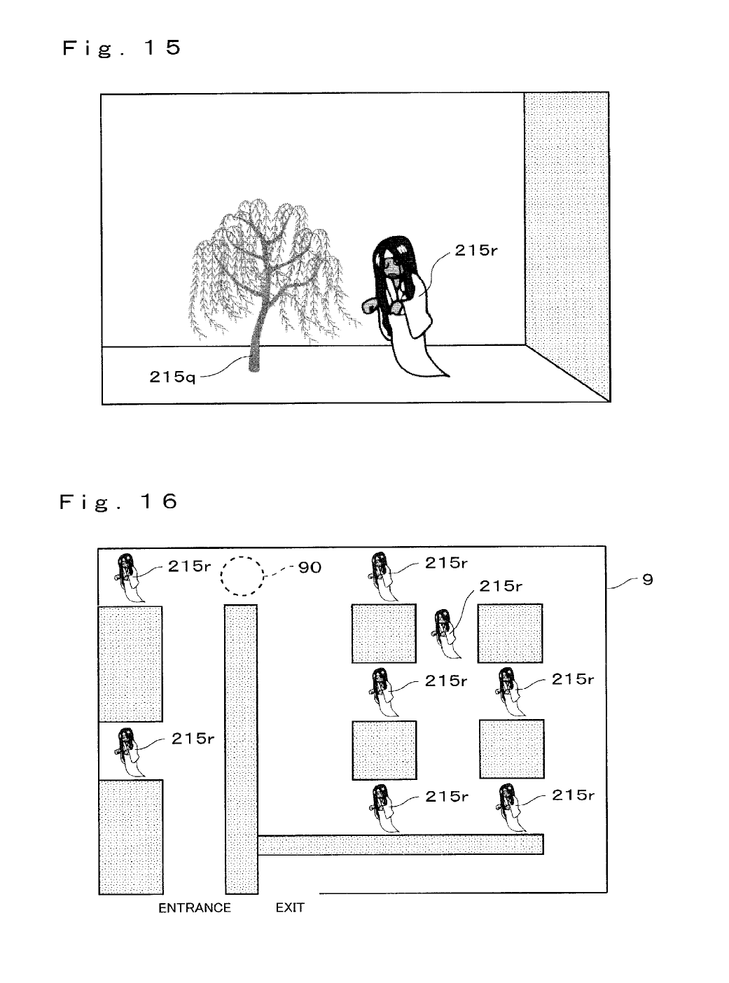

FIGS. 17 to 19 illustrate display examples of the ghost image 215r. Bold arrow in FIGS. 17 to 19 represents the route of the user within the augmented reality space 9.

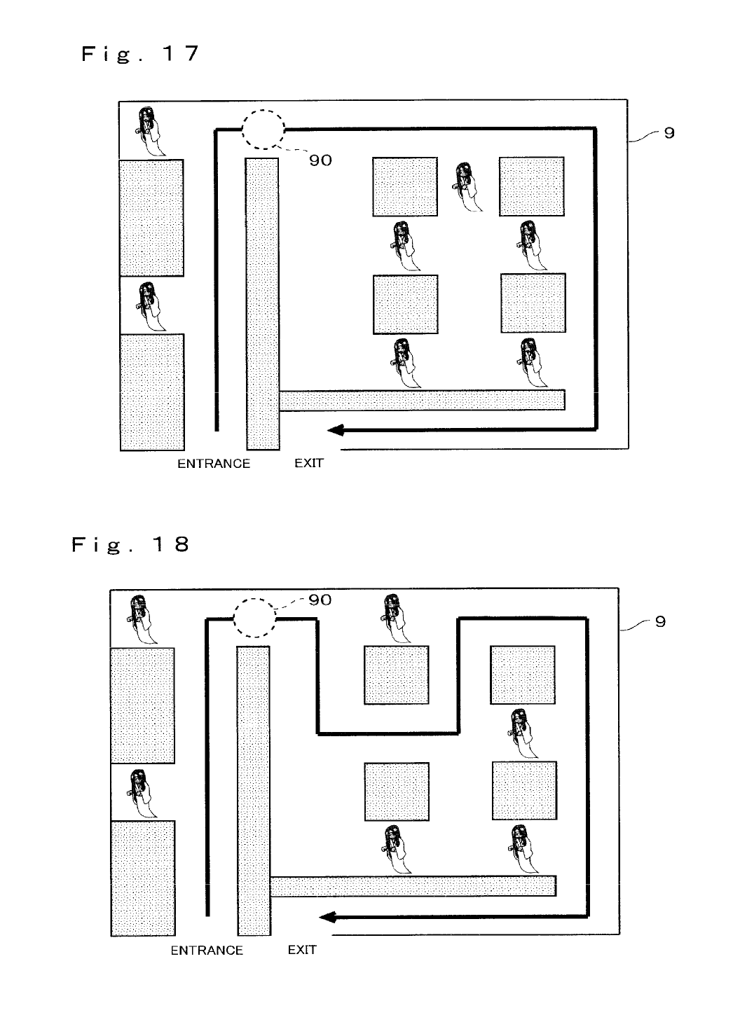

The augmented reality providing system 1b in the still other preferred embodiment changes the position at which the ghost image 215r is actually displayed in accordance with the physiological status of the user when that user has arrived at the decision position (circle 90). That is, from the biological information 216 at the decision position, the ghost image 215r is displayed only at the positions shown in FIG. 17 when the heart rate exceeds 120 [bpm], is displayed only at the positions shown in FIG. 18 when the heart rate is between 90 to 120 [bpm], and is displayed only at the positions shown in FIG. 19 when the heart rate is below 90 [bpm].

In this manner, for the user who has been decided to be very surprised by analysis of the biological information 216, the ghost image 215r is displayed to provide a relatively short and simple moving route (FIG. 17). Also, the number of ghosts that user is to encounter (the ghost images 215r) is minimized.

On the other hand, for the user who has been decided to be surprised little, the ghost image 215r is displayed in such a manner that a relatively long and complicated moving route (FIGS. 18 and 19) is provided. Also, the number of the ghosts that user is to encounter (the ghost images 215r) is set to be increased.

As described above, the augmented reality providing system 1b in the still other preferred embodiment can provide the augmented reality in accordance with the physiological status of the living body by outputting the output information 215 in accordance with the biological information 216 measured by the biological sensor 28.

The degree of surprise of the user can be also decided by using an acceleration sensor and counting the number of times the acceleration largely changes, for example. In an exemplary method that can be considered, the display pattern in FIG. 17 is applied to the user who was surprised twice or more from the entrance to the decision position, the display pattern in FIG. 18 is applied to the user who was surprised once, and the display pattern in FIG. 19 is applied to the user who was not surprised.

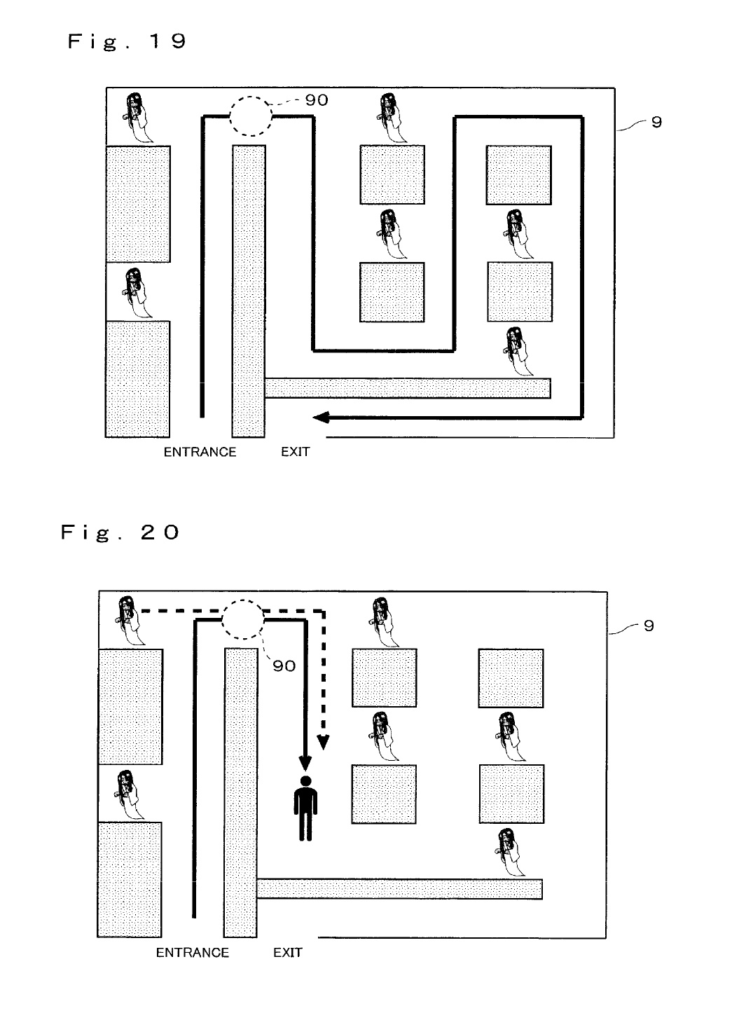

FIG. 20 illustrates a modified example in a case where the display of the ghost image 215r is changed in the still other preferred embodiment. Broken arrow in FIG. 20 represents the trace of the display position of the ghost image 215r in a case where the display position of the ghost image 215r is sequentially changed.

In FIGS. 17 to 19, it is decided whether to display the respective ghost images 215r based on the biological information 216. However, for the user who is regarded as being almost unsurprised, the display position of a specific ghost image 215r may be successively changed in such a manner that that ghost image 215r follows the user.

Although in the still other preferred embodiment, the route of the user is changed by changing the display of “ghosts” as the virtual objects, a way of changing the route is not limited thereto. For example, a wall as a virtual thing is displayed between the real walls, thereby making the wall look as if the wall extended and prevented the user from passing therethrough and causing the user to change its route.

Also in the augmented reality providing system 1b in the still other preferred embodiment, devices corresponding to the reference position providing device 10 and the database server 11 may be provided while the contactless IC card unit 26 and the communication unit 27 are provided in the portable terminal device 2b, as in the augmented reality providing system 1 in the preferred embodiment. By this structure, the augmented reality providing system 1b in the still other preferred embodiment can also deal with the update of the reference information 103 and the candidate information 112 easily.

In particular, in the application simulating the “haunted house” described in the still other preferred embodiment, it is preferable to change the actual layout, the display form of the virtual objects, and the like at a relatively short cycle for attracting repeaters. In this case, update of the reference information 103 and the candidate information 112 may be required. However, also in such a case, it is possible to deal with the update by storing the reference information 103 and the candidate information 112 that have been updated in a portable recording medium such as an SD card and supplying them to the portable terminal device 2b.

The application to which the present invention is applied is not limited to those shown in the embodiments described above, but more variations can be considered.

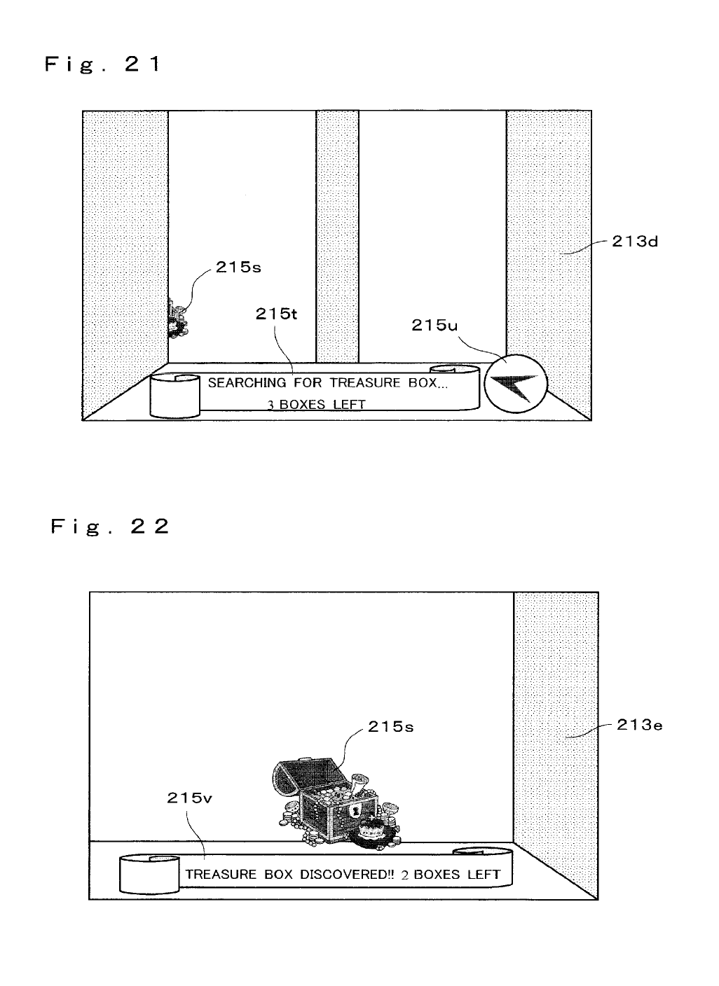

FIG. 21 and FIG. 22 illustrate display examples of augmented reality of a search application provided by an augmented reality providing system 1c in further another preferred embodiment. The search application is an application in which a user searches for a target (virtual object) such as a treasure box installed in the augmented reality space 9 by using the portable terminal device 2. The augmented reality providing system 1c in the further other preferred embodiment can be achieved by hardware structure that is the same as the augmented reality providing system 1 in the preferred embodiment, for example.

As illustrated in FIG. 21, the captured image information 213d as the real portion, a treasure box image 215s as the target, and a message 215t and a compass image 215u that indicate information as a clue for the search are synthesized and displayed on the display unit 23. The treasure box image 215s, the message 215t, and the compass image 215u are the output information 215 selected from the candidate information 112.

In the augmented reality space 9 provided by the search application, the user uses the message 215t and the compass image 215u output to the portable terminal device 2 and searches for the virtual object (treasure box).

When the current position and the current posture of the user fall within a predetermined range, it means that the target is found. That is, the augmented reality formation unit 202 selects the treasure box image 215s as the output information 215 on condition that the position information 214 falls within the predetermined range, thereby the screen shown in FIG. 22 is displayed. In the example of FIG. 22, the treasure box image 215s and a message 215v indicating the discovery of the treasure box are displayed together with the captured image 213e representing the real portion.

In the further other preferred embodiment, the example is described in which the treasure box as the target is searched for. However, the target is not limited thereto. For example, an animal represented as a virtual object can be set as the target. In this case, it is preferable that the voice of that animal is adjusted in accordance with the position information 214 of the user and is output as information that is a clue for the search from a structure corresponding to the speaker 29. The adjustment of the sound such as the voice is not limited to the volume adjustment in accordance with the distance between the animal as the target and the user. The adjustment of the direction of sound source in which the user perceives the sound by mutual adjustment of the volumes reaching the right and left ears of the user is also effective. Moreover, the adjustment can be made by the presence or absence of a shield between the user and the animal (it does not matter whether the shield is a real thing or a virtual object).

Various preferred embodiments of the present invention are described above. However, the present invention is not limited to the above-described preferred embodiment, but can be modified in various ways.

For example, the respective steps shown in the above preferred embodiment are mere examples, and the order and the contents thereof are not limited to those described above. That is, the order or the contents can be changed as appropriate, as long as the same effects can be obtained. For example, the orders of the step in which the image capturing unit 25 starts image capturing (Step S5) and the step in which the group of sensors 24 starts the measurement (Step S6) may be changed.

The functional blocks (the card control unit 200, the position and posture identification unit 201, the augmented reality formation unit 202, and the like) shown in the above preferred embodiment are described as being achieved in form of software by the operation of the CPU 20 in accordance with the program 210. However, a portion or all of those functional blocks may be formed by dedicated logic circuits to be achieved by hardware.

The index element may be a barcode representing the information on the reference position and the posture at the reference position. For example, the barcode that is read at the reference position with a specific posture may be provided near the augmented reality space 9 and be captured and read by the image capturing unit 25.

In the above preferred embodiment, the example is described in which the group of sensors 24 and the output element (the display unit 23, 23a and the speaker 29) are provided in the same device. However, those may exist in different devices. For example, a pet (object) may be provided with the group of sensors 24 attached thereto and be released into the augmented reality space 9, and a virtual object may be output to the output element provided in a device carried by the user in accordance with the movement of that pet, thereby augmented reality is provided. Moreover, an application can be considered in which the user throws a ball (object) including the group of sensors 24 therein within the augmented reality space 9, the trajectory of that ball is calculated in accordance with the position at the moment when the ball is thrown and the acceleration, and the trajectory of a virtual object (e.g., a spear or a ball of fire by magic) corresponding to that ball or the situation of an enemy as the target is displayed in the device of the user on hand (output element).

1. An augmented reality providing system comprising:
a sensor configured to measure information on movement;
a first storage element configured to store a reference position of the sensor;
a decision element configured to decide whether or not the sensor is located at the reference position;
a position identification element configured to, after decision by the decision element that the sensor is located at the reference position, identify a current position of the sensor based on the reference position stored in the first storage element and the information on the movement measured by the sensor; and
an output element configured to output output information in accordance with the current position of the sensor identified by the position identification element, to represent augmented reality.

2. The augmented reality providing system according to claim 1, wherein
the first storage element stores a posture of the sensor at the reference position,
the augmented reality providing system further includes a posture identification element configured to, after the decision by the decision element that the sensor is located at the reference position, identify a current posture of the sensor based on the posture of the sensor at the reference position stored in the first storage element and the information on the movement measured by the sensor, and
the output element outputs the output information in accordance with the current posture of the sensor identified by the posture identification element.

3. The augmented reality providing system according to claim 1, further comprising:
a portable terminal device of which a position is variable; and
an index element of which an absolute position is known, wherein the portable terminal device includes:
the sensor; and
an acquisition element configured to acquire individual information of the index element, and
the decision element decides the sensor as being located at the reference position at a time of acquisition of the individual information of the index element by the acquisition element.

4. The augmented reality providing system according to claim 3, wherein
the index element is an installation type device fixed at the absolute position, and
the acquisition element includes a first communication element that performs near-field wireless communication with the installation type device when the sensor is located at the reference position.

5. The augmented reality providing system according to claim 4, wherein
the installation type device sends the reference position to the portable terminal device while the near-field wireless communication is performed between the portable terminal device and the installation type device.

6. The augmented reality providing system according to claim 4, wherein
the installation type device sends candidate information that is a candidate of the output information to the portable terminal device while the near-field wireless communication is performed between the portable terminal device and the installation type device.

7. The augmented reality providing system according to claim 3, wherein
a plurality of the portable terminal devices are provided,
each of the portable terminal devices includes:
a second communication element configured to perform wireless data communication with another one of the portable terminal devices within an augmented reality space; and
the output element, wherein
the second communication element receives the current position of the sensor included in the other one of the portable terminal devices by the wireless data communication, and
the output element outputs the output information in accordance with the current position of the sensor included in the other one of the portable terminal devices, received by the second communication element.

8. The augmented reality providing system according to claim 3, wherein
the portable terminal device includes:
a third communication element configured to perform wireless data communication with a terminal device within an augmented reality space; and
the output element, wherein
the third communication element receives unique information related to the terminal device via the wireless data communication, and
the output element outputs the output information in accordance with the unique information related to the terminal device received by the third communication element.

9. The augmented reality providing system according to claim 1, further comprising a second storage element configured to store information on an object which is accompanied by the sensor, wherein
the output element outputs the output information in accordance with the information on the object stored in the second storage element.

10. The augmented reality providing system according to claim 1, further comprising a biological sensor configured to measure biological information related to a living body, wherein
the output element outputs the output information in accordance with the biological information measured by the biological sensor.

11. A non-transitory computer-readable storage medium storing computer-readable instructions that, when executed by a computer, cause the computer to perform an augmented reality providing method, the method comprising the steps of;
measuring information on movement by a sensor;
storing a reference position of the sensor in a first storage element;
deciding whether or not the sensor is located at the reference position;
after decision that the sensor is located at the reference position, identifying a current position of the sensor based on the reference position stored in the first storage element and the information on the movement measured by the sensor; and
outputting output information in accordance with the identified current position of the sensor to represent augmented reality.

12. An augmented reality providing method comprising the steps of;
measuring information on movement by a sensor;
storing a reference position of the sensor in a first storage element;
deciding whether or not the sensor is located at the reference position;
after decision that the sensor is located at the reference position, identifying a current position of the sensor based on the reference position stored in the first storage element and the information on the movement measured by the sensor; and
outputting output information in accordance with the identified current position of the sensor to represent augmented reality.
